(19) United States
(12) Patent Application Publication
(10) Pub. No.: US 2012/0122066 A1
(43) Pub. Date: May 17, 2012

(54) ONLINE IMMERSIVE AND INTERACTIVE EDUCATIONAL SYSTEM

(75) Inventors: Doug Dohring, Glendale, CA (US); William McCaffrey, Glendale, CA (US); Stephanie Yost, Glendale, CA (US); David Hendry, La Crescenta, CA (US); Lee Borth, Sunland, CA (US)

(73) Assignee: AGE OF LEARNING, INC., Glendale, CA (US)

(21) Appl. No.: 12/946,538

(22) Filed: Nov. 15, 2010

(51) Int. Cl. G09B 5/00

(52) U.S. Cl. 434/308; 434/157

(57) ABSTRACT

An immersive and interactive educational system for a child aged about 1 to about 10 years, comprising a digital processing device that is connected to the Internet and visual and audio content that creates an immersive and interactive educational environment for the child. The educational environment is characterized by comprising at least three subjects appropriate for the child, wherein each subject comprises a plurality of levels of learning; a plurality of learning activities associated with each subject; a software module for monitoring the progress of the child in each of the subjects; a software module for rewarding the child for completing an activity; and a software module for creating an avatar to represent the child. The plurality of activities associated with each subject teaches toward one or more educational objectives in a subject, is substantially free of activities not teaching toward one or more educational objectives in a subject, includes a book and at least one additional activity appropriate for the child, and includes one or more activities comprising a plurality of skill levels.

### BACKGROUND OF THE INVENTION

Education is the process by which an individual gains knowledge, skills, and values that enable the individual to operate successfully in society and achieve personal goals. Etymologically, the word education is derived from the Latin educare, “bring up” and ducere, “to lead.” Higher levels of education offer benefits, both intangible and economic, for students and the societies in which they live. Personal benefits can include a feeling of fulfillment, social and economic mobility, and increased quality of life.

Jacob Mincer's human capital theory of labor economics forms the basis for many modern economists' view that education is an investment, by the student as well as society, in the acquisition of skills and knowledge, which will increase earnings and provide long-term benefits. According to the Census Bureau, over an adult's working life, high school graduates earn an average of $1.2 million; associate's degree holders earn about $1.6 million; and bachelor's degree holders earn about $2.1 million. On a larger scale, countries with high enrollment and graduation rates have grown faster than countries without.

### SUMMARY OF THE INVENTION

Studies acknowledged by the Centers for Disease Control and Prevention (CDC) confirm the nearly universal view that the early years of a child's life are crucial for cognitive, social, and emotional development. Early education, from age 0 to 5 years, is especially critical. During this period, children develop the foundation for their enduring language, motor, and analytical skills. Education experts recommend fostering the development of these skills in young children through activities such as conversing, playing games, making arts and crafts, reading, singing, and counting with them, as well as by helping them explore their surroundings and engaging in imaginative play.

Engagement indicates the degree of involvement, intensity, contribution, and ownership that an individual has with regard to an experience. The more engaged a child is with a learning activity, the more likely he/she is to assimilate the activity's educational content. An effective educational environment should include features designed to engage the intended audience of children at a high level.

It is important to note that not all children learn in the same way. Howard Gardner, developmental psychologist and Professor of Cognition and Education at Harvard University, elucidated eight separately identifiable types of intelligence: linguistic, logic-mathematical, musical, spatial, bodily kinesthetic, naturalist, interpersonal, and intrapersonal. An effective educational environment should offer different types of activities, such as books, games, puzzles, music, and art, which support different types of intelligence and learning styles.

Technology is an increasingly influential factor in education and offers new opportunities to create powerful learning tools. Multimedia technology provides new ways to engage students, such as through the creation of an interactive online educational environment. In such an environment, students can be given flexibility to choose both what they learn and how they learn it. This helps to address multiple learning modes, as well as keep the learning experience engaging. Despite these potentials, current online educational environments do not include all of the features necessary to effectively engage children, especially young children aged about 1 to 10.

There are currently two major types of interactive online environments for children aged about 1 to 10. The first type is exemplified by environments typically created by entertainment, media, and toy enterprises. These environments are often entertaining, but offer little serious educational value. In these websites, the primary agenda appears to be less to educate than to entertain, build recognition of branded characters, and promote interlinked media and toy businesses. The second type of interactive online environment is exemplified by those often created by educators. These environments offer recognized educational content, but lack the depth and breadth of features and functionality truly effective to engage and retain children aged about 1 to 10. As a result, children, as well as their mentors, are forced to choose between interactive online environments with minimal educational value and those with educational content that does not effectively engage children. If given the choice, children will gravitate to the “fun” websites instead of the “educational” websites.

But, this need not be the case. To be effective, an online educational environment for children aged about 1 to 10 should include multiple subjects, selected from those recognized and traditionally taught, such as reading, math, science, social studies, art, and music. Moreover, the subjects should be subdivided into levels appropriate for the age and/or development of each child. The activities offered in an effective online educational environment should be directly related to one or more educational objectives in one or more subjects. And, the environment should offer diverse types of activities, such as books, games, puzzles, music, and art, which support a wide range of learning styles. Accordingly, we have identified a long-felt and unmet need for an online educational environment for children aged about 1 to 10 that offers diverse types of activities that teach toward educational objectives within the full compliment of subjects and includes features and functionality that are truly fun so as to effectively engage children of this age.

Disclosed herein are computer-based immersive and interactive educational systems, methods of education, and media encoded with computer programs. In some embodiments, the computer-based immersive and interactive educational systems are World Wide Web-based. In other embodiments, the educational systems are based on data storage devices including, by way of non-limiting examples, CD-ROMs, DVDs, flash memory devices, magnetic disk drives, and optical disk drives. In other embodiments, the educational systems are intranet-based. In still other embodiments, the educational systems are cloud computing-based.

In some embodiments, the educational system for a child aged about 1 to 10 comprises a digital processing device that is connected to the Internet, and visual and audio content provided to the digital processing device via the Internet that creates an immersive and interactive educational environment. The digital processing device is suitable for use by a child and comprises an operating system configured to perform executable instructions, a memory device, a display, a sound output device, and an input device. The visual and audio content provided to the digital processing device is at least partially stored in the memory of the digital processing device. The immersive and interactive educational environment is characterized by comprising: at least three subjects appropriate for the child, wherein each subject comprises a plurality of levels of learning; a plurality of activities associated with each subject; a software module for monitoring the progress of the child in each of the subjects; a software module for rewarding the child for completing an activity; and a software module for creating an avatar to represent the child. In some embodiments, each activity in the plurality of activities associated with each subject is interconnected by an instructional plan designed to accomplish one or more specific educational objectives through the mutual reinforcement of individual activities that address different modes of learning. In some embodiments, one or more activities in the plurality of activities associated each subject are available in a language other than English.

One aspect of the educational system disclosed herein is at least three subjects comprising a plurality of levels of learning. In some embodiments, each subject comprises at least three levels of learning. In further embodiments, each subject comprises six levels of learning. In still further embodiments, each subject further comprises a level of learning for toddlers. In some embodiments, the subjects are selected from those appropriate for children aged about 1 to 10 such as language arts, mathematics, social studies, science, music and other performing arts, visual art, additional languages, health, fitness and sports, and information technology. In further embodiments, the educational system addresses appropriate topics such as letters, sight words, phonics, word families, reading, spelling, grammar, English, writing, composition, literature, poetry, journalism, numbers, counting, pre-algebra, algebra, geometry, citizenship, ethics, geography, U.S. government, U.S. history, world history, earth science, biology, chemistry, colors, shapes, drawing, photography, sign language, and computer skills.

Another aspect of the educational system disclosed herein is a plurality of learning activities associated with each subject. The plurality of activities teaches toward one or more educational objectives in a subject, is substantially free of activities not teaching toward one or more educational objectives in a subject, includes a book and at least one additional activity appropriate for the child, and includes one or more activities comprising a plurality of skill levels. In some embodiments, one or more activities comprise two or more skill levels. In some embodiments, the plurality of activities includes one or more activities with content unique to the educational system and not available elsewhere.

In some embodiments, books comprise pages with text and images, an animated page flipping format, an automatic page flipping mode, a manual page flipping mode, audio of the book read, play/pause controls, a progress indicator, and optionally, highlighting of words in the book corresponding to the audio. In other embodiments, books comprise a single page with text and images, audio of the book read, play/pause controls, a progress indicator, and optionally, highlighting of words in the book corresponding to the audio. In other embodiments, books comprise audio of the book read, images corresponding to the audio, play/pause controls, and a progress indicator. In some embodiments, books further comprise video or animation. In some embodiments, books further comprise a means to record voice narration of the book and a means for the child or a mentor to share books personalized by narration with others. In some embodiments, the plurality of activities includes one or more puzzles, wherein at least one puzzle is a jigsaw puzzle or a cutout puzzle. In some embodiments, the plurality of activities includes one or more music activities, wherein at least one music activity is a song, book, puzzle, game, art activity, or an interactive musical instrument. In some embodiments, songs comprise text of the lyrics, audio of the lyrics sung, and optionally, a bouncing ball animation over text of the lyrics corresponding to audio of the lyrics sung. In further embodiments, the child experiences songs through an interactive virtual audio player. In some embodiments, songs further comprise a means to reduce or remove the voice track, a means to record singing of the lyrics, and a means for the child or a mentor to share songs personalized by singing with others. In some embodiments, the plurality of activities includes one or more art activities, wherein at least one art activity is drawing, tracing, dot-to-dot, coloring, painting, paint-by number, paint-by-letter, and paint-by-word. In some embodiments, the plurality of activities includes one or more games, wherein at least one game is designed to increase skills in academic topics such as letter recognition, letter sounds, letter sound recognition, letter tracing, letter matching, letter fill-in, word recognition, word sounds, recognition of sounds in words, sight words, word tracing, paint-by-letter, paint-by-word, spelling, number recognition, counting, number tracing, number matching, number fill-in, more or less, shape tracing, shape recognition, primary color recognition, secondary color recognition, color matching, animal recognition, or object recognition.

Another aspect of the educational system disclosed herein is visual and audio content. In some embodiments, the visual and audio content includes one or more of: text, images, video, audio, motion, interactivity, and animation. In further embodiments, the visual and audio content is in a format selected from one or more of: Flash®, QuickTime®, Real Media®, Windows Media®, Silverlight®, Java™, HTML 5, XHTML 5, and Unity®. In further embodiments, the visual and audio content is substantially in Adobe® Flash® format.

Another aspect of the educational system disclosed herein is a software module for monitoring the progress of the child in each of the subjects. In some embodiments, the software module for monitoring the progress of the child allows both the child and a mentor to the child to independently monitor the progress of the child. In some embodiments, the software module for monitoring the progress of the child in each of the subjects includes on-screen progress displays. In some embodiments, the software module for monitoring the progress of the child in each of the subjects includes printable reports.

In some embodiments, the progress displays are adapted for use by a mentor to the child, wherein said progress displays indicate percentage completion of one or more subjects, percentage completion of one or more levels of learning within each subject, and completion of each activity associated with each subject. In further embodiments, the progress displays indicate the number of times each activity has been completed. In additional embodiments, the progress displays indicate performance by metrics such as raw scores or percentages. Some embodiments might also indicate performance by metrics such as grades. In additional embodiments, the progress displays indicate time spent by the child. In some embodiments, the software module for monitoring the progress of the child in each of the subjects includes printable reports adapted for use by a mentor to the child.

In some embodiments, the progress displays are adapted for use by the child. In some embodiments, the software module for monitoring the progress of the child in each of the subjects includes printable reports adapted for use by the child.

In some embodiments, the software module for monitoring the progress of the child includes a visual indicator adapted for use by the child, wherein said visual indicator displays the percentage of the activities completed within a level.

In some embodiments, the software module for monitoring the progress of the child includes a visual indicator adapted for use by the child, wherein said visual indicator displays the activities completed within a level. In some embodiments, the visual indicator is characterized by representing the level of learning as a linear succession and representing lessons, comprising groups of activities, as points in the linear succession. In further embodiments, the linear succession is further represented as a map, path, or road and said lessons comprising groups of activities are further represented as waypoints or stops on the map, path, or road. In some embodiments, the software module for monitoring the progress of the child further includes a visual indicator, adapted for use by the child, which displays lessons as a group of selectable activity icons. In further embodiments, the group of selectable activity icons is further represented on a whiteboard, chalkboard, or bulletin board.

Another aspect of the educational system disclosed herein is a software module for rewarding the child for completing an activity. In some embodiments, the software module for rewarding the child creates a virtual economy comprising one or more units awarded for completing an activity and one or more stores for exchanging awarded units for privileges within the educational system and virtual items used in system. In further embodiments, the units are represented as virtual tickets. In still further embodiments, at least one store for spending awarded units is an avatar store, a pet store, an arcade, a movie theater, an aquarium store, or an emoticon store.

Another aspect of the educational system disclosed herein is a software module for creating, maintaining, and enhancing an avatar to represent the child in the educational system. In some embodiments, the software module for creating an avatar to represent the child includes means for selecting the form of the avatar and clothing, physical features, and items associated with the child's avatar. In some embodiments, the software module for creating an avatar to represent the child further includes means for capturing, zooming, and panning images of the child's avatar for display in the educational system.

In some embodiments, the educational system further comprises a top-level graphic user interface (GUI) characterized by representing a classroom environment. In further embodiments, the top-level GUI includes a representation of a teacher, wherein a mentor to the child optionally customizes the appearance of the teacher. In other embodiments, the top-level GUI is characterized by representing other environments retentive of children aged about 1 to 10.

In some embodiments, the educational environment further comprises a glossary of words used in one or more activities. In some embodiments, the educational environment further comprises an encyclopedia, a dictionary, and/or a thesaurus. In some embodiments, the educational environment further comprises a software module for designating favorite activities, wherein the child optionally selects his/her favorites and they will appear in a special area that displays those activities he/she has designated as favorites. In some embodiments, the educational environment further comprises a software module for rating activities, wherein the child has the option to express an opinion of one or more completed activities. In further embodiments, the child has the option to express an opinion of one or more completed activities on a numeric scale from one to five. In some embodiments, the educational environment further comprises a directory of printable activities, wherein at least one printable activity is coloring, drawing, writing, tracing, dot-to-dot, paint-by-number, paint-by-letter, paint-by-word, word search, and number word search.

In some embodiments, one aspect of the educational system disclosed herein is one or more sub-level GUIs characterized by representing environments familiar to children aged about 1 to 10. In some embodiments, the educational environment further comprises a farm-themed sub-level GUI. In some embodiments, the educational environment further comprises a zoo-themed sub-level GUI. In some embodiments, the educational environment further comprises one or more sub-level GUIs with a theme conducive to engaging a child aged about 1 to 10 including, by way of non-limiting examples, libraries, laboratories, medical facilities, cities, sporting events, school buses, amusement parks, carnivals, shopping malls, markets, kitchens, garages, museums, playgrounds, gardens, deserts, mountains, lakes, undersea environments, extraterrestrial environments, and arctic or Antarctic environments.

In some embodiments, the educational environment disclosed herein includes multiple navigational modes. In further embodiments, the navigational modes include a sequenced navigational mode, a guided navigational mode, and an independent navigational mode.

In some embodiments, the educational environment disclosed herein includes a sequenced navigational mode wherein the system presents to the child a predetermined sequence of more than one activity in one or more subjects wherein the child must complete each preceding activity in the sequence to progress to the next. In some embodiments, each step in the predetermined sequence of activities comprises either an activity or a set of alternate activities. In further embodiments, where the next step in a predetermined sequence of activities is a singular activity, the educational system presents the activity to the child. In further embodiments, where the next step in a predetermined sequence of activities is a set of alternate activities, the educational system presents one activity from the set of alternate activities to the child.

In some embodiments, the educational environment disclosed herein includes a guided navigational mode wherein the educational system presents to the child one or more activities in one or more subjects selected by a mentor from among a population of activities to create a subpopulation of activities. In some embodiments, in guided navigational mode, the child selects activities from among the subpopulation of activities.

In some embodiments, the educational environment disclosed herein includes an independent navigational mode wherein the child freely selects activities from among the full population of activities.

In still further embodiments, the child has the option to switch between available navigational modes. In some embodiments of the educational system disclosed herein, the availability of each navigational mode is determined by a mentor to the child or by an instructional designer. In further embodiments, the child has the option to freely use any navigational mode offered by the educational system. In other embodiments, the child has the option to select one or more navigational modes in a settings area of the educational environment. In some of these embodiments, the flexibility in finding, browsing, and exploring learning activities provided by multiple navigational modes contributes to the interactive and immersive nature of the educational system.

In some embodiments, the educational system further comprises a software module adapted for conducting e-commerce transactions. In further embodiments, the e-commerce transactions create subscription-based access to the educational environment. In still further embodiments, the transactions are sales of goods or other services.

The term “age” as used herein, refers to the length of time that a person has lived and also serves as an expression of a person's maturational progress in terms of social functioning, psychological functioning, mental functioning, cognitive functioning, and motor skills.

The term “child” as used herein, refers to a person between the stages of conception and puberty and also refers to a person with social, psychological, mental, or cognitive functioning comparable to such a person.

The term “mentor” as used herein, refers to a person who has an interest in, or responsibility for, facilitating or furthering the educational development of a child and includes, by way of non-limiting examples, a parent, step-parent, adoptive parent, foster parent, grandparent, guardian, relative, friend, guide, instructor, teacher, or professor, of a child.

The term “instructional designer” as used herein, refers to any person who designs and/or evaluates learning activities, and grouped sequences of activities, that are elements of an educational system.

The term “instructional plan” as used herein, refers to a plan, conceived by at least one instructional designer or at least one mentor to the child, designed to accomplish one or more specific educational objectives through the mutual reinforcement of individual activities that address different modes of learning.

### BRIEF DESCRIPTION OF THE DRAWINGS

FIG. 1 shows a non-limiting example of an educational system including a top-level GUI characterized by representing a metaphor suitable for learning; in this case, a preschool classroom environment.

FIG. 2 shows a non-limiting example of software module for customizing a representation of an instructor in a representation of a classroom environment such as that illustrated by FIG. 1; in this case, a software module for customizing appearance.

FIG. 3 shows non-limiting examples of reading-related activities; in this case, a collection of reading-related activities, where the child has the option to sort the activities by activity type and has the option to selectively make appropriate activities available based on each activity's association with one or more levels of learning.

FIG. 4 shows non-limiting examples of math-related activities; in this case, a collection of math-related activities, where the child has the option to sort the activities by activity type and has the option to selectively make appropriate activities available based on each activity's association with one or more levels of learning.

FIG. 5 shows non-limiting examples of science and social studies-related activities (“World Around Us”); in this case, a collection of science and social studies-related activities, where the child has the option to sort the activities by activity type and has the option to selectively make appropriate activities available based on each activity's association with one or more levels of learning.

FIG. 6 shows non-limiting examples of art and color-related activities; in this case, a collection of art and color-related activities, where the child has the option to sort the activities by activity type and has the option to selectively make appropriate activities available based on each activity's association with one or more levels of learning.

FIG. 7 shows non-limiting examples of music activities; in this case, a collection of music activities including songs, other music-related activities such as books, puzzles, and games, and an interactive piano.

FIG. 8 shows a non-limiting example of a music activity; in this case, a song teaching toward an educational objective in art and colors and represented by an interactive virtual audio player.

FIG. 9 shows non-limiting examples of reading activities; in this case, reading activities represented as books in a library sortable by subject or by type of story.

FIG. 10a shows a non-limiting example of a reading activity; in this case, a multipage, interactive virtual book.

FIG. 10b shows a non-limiting example of a reading activity; in this case, a single-page, interactive virtual book adapted for nursery rhymes and short poems.

FIG. 10c shows a non-limiting example of a reading activity; in this case, a “Read-to-Me” virtual book adapted for use by toddlers.

FIG. 11 shows non-limiting examples of puzzles; in this case, a collection of puzzles sortable by subject.

FIG. 12 shows a non-limiting example of a cutout puzzle; in this case, a cutout puzzle that includes a plurality of skill levels, teaches toward an educational objective in math, and identifies the puzzle pieces with spoken word audio when they are moved.

FIG. 13 shows a non-limiting example of a jigsaw puzzle; in this case, a jigsaw puzzle that includes a plurality of skill levels, teaches toward an educational objective in reading, and identifies a letter with spoken word audio and uses the letter in a sentence upon completion.

FIG. 14 shows non-limiting examples of games; in this case, a collection of games sortable by subject.

FIG. 15 shows a non-limiting example of a game; in this case, a memory matching game teaching toward an educational objective in art and colors.

FIG. 16 shows a non-limiting example of an art activity; in this case, a coloring activity teaching toward an educational objective in reading.

FIG. 17 shows a non-limiting example of an art activity; in this case, a dot-to-dot activity teaching toward an educational objective in reading.

FIG. 18 shows a non-limiting example of an art activity; in this case, a paint-by-number activity teaching toward an educational objective in shapes.

FIG. 19 shows a non-limiting example of a printable activity; in this case, a printable coloring worksheet teaching toward an educational objective in reading.

FIG. 20 shows a non-limiting example of a themed sub-level GUI; in this case, a zoo-themed sub-level GUI providing access to zoo-related activities that teach toward one or more educational objectives in any subject.

FIG. 21 shows a non-limiting example of a themed sub-level GUI; in this case, farm-themed sub-level GUI providing access to farm-related activities that teach toward one or more educational objectives in any subject.

FIG. 22 shows a non-limiting example of a glossary of words used in one or more activities included in an educational environment.

FIG. 23 shows a non-limiting example of a software module for monitoring the progress of the child that includes a display of the child's progress for the benefit of a mentor; in this case, the progress display indicates percentage completion of multiple subjects, percentage completion of multiple levels within each subject, and completion of each activity associated with each level within each subject.

FIG. 24 shows a non-limiting example of a software module for monitoring the progress of the child that includes a display of the child's progress for the benefit of the child; in this case, the progress display indicates percentage completion of multiple subjects and percentage completion of multiple levels within each subject.

FIG. 25 shows a non-limiting example of a visual indicator, for the benefit of the child, that represents the percentage of activities completed within a sequence of activities; in this case, a bar chart indicating the percentage of activities completed within a level of a multi-subject sequence.

FIG. 26 shows a non-limiting example of a predetermined sequence of activities represented in a GUI as a linear succession; in this case, a path or road, as well as a non-limiting example of lessons represented as points in the linear succession; in this case, waypoints or stops along the path or road.

FIG. 27 shows a non-limiting example of a lesson represented in a GUI as a group of selectable activity icons; in this case, a group of selectable activity icons further represented on a whiteboard or bulletin board.

FIG. 28 shows a non-limiting example of units used in a virtual economy that are awarded for completing an activity; in this case, virtual tickets dispensed from a virtual ticket machine.

FIG. 29 shows a non-limiting example of a virtual shopping center of stores for exchanging units used in a virtual economy; in this case, a virtual shopping center that provides access to an avatar store, an aquarium store, and an emoticon store.

FIG. 30 shows a non-limiting example of an avatar store; in this case, an avatar store that allows the child to exchange awarded units used in a virtual economy for clothing, features, and other items to customize, maintain, and enhance an avatar to represent the child in the educational environment.

FIG. 31a shows a non-limiting example of a software module for creating an avatar to represent the child; in this case, a software module for creating an avatar to represent the child that includes means for selecting clothing and physical features associated with the child's avatar.

FIG. 31b shows a non-limiting example of a software module for creating a room associated with the child's avatar; in this case, a software module for creating a room that includes means for selecting decorations, furniture, and location.

FIG. 32 shows a non-limiting example of a means for viewing and sorting activities designated as favorites; in this case, the child has the option to view, sort, and access favorites by type of activity.

FIG. 33 shows a non-limiting example of a software module for allowing children using the system to communicate with each other; in this case, a virtual mail system.

### DETAILED DESCRIPTION OF THE INVENTION

Existing online educational systems fall short of simultaneously fulfilling both of the elements required to engage and educate children aged about 1 to 10. None offers diverse types of activities that teach toward educational objectives within the full compliment of appropriate subjects while also including features and functionality that are truly fun so as to effectively engage children of this age.

Thus, a primary objective of the educational systems, methods, and computer programs described herein is to facilitate and enhance the education of children aged about 1 to 10 by utilizing computer technology to accommodate diverse learning styles while engaging children with educational content. Advantages of the systems described herein include, but are not limited to, offering activities interconnected by an instructional plan designed to accomplish educational objectives in specific subjects while supporting many different learning styles and offering features that engage children aged about 1 to 10 so that they enjoy learning and return regularly to the educational environment.

### Immersive and Interactive Educational System

Described herein, in some embodiments, are immersive and interactive educational systems comprising a digital processing device that is connected to the Internet, and visual and audio content provided to the digital processing device via the Internet. The visual and audio content is at least partially stored in the memory of the digital processing device and creates an immersive and interactive educational environment for a child aged about 1 to 10. The digital processing device comprises an operating system configured to perform executable instructions, a memory device, a display, a sound output device, and an input device, and is characterized as being suitable for use by the child.

The educational environment is further characterized by comprising at least three subjects appropriate for the child, wherein each subject comprises a plurality of levels of learning, a plurality of activities associated with each subject, a software module for monitoring the progress of the child in each of the subjects, a software module for rewarding the child for completing an activity, and a software module for creating an avatar to represent the child.

The plurality of activities associated with each subject teaches toward one or more educational objectives in a subject, is substantially free of activities not teaching toward one or more educational objectives in a subject, and includes a book and at least one additional activity appropriate for the child. One or more activities in the plurality of activities associated with each subject comprises a plurality of skill levels. In some embodiments, each activity in the plurality of activities is interconnected by an instructional plan designed to accomplish one or more specific educational objectives through the mutual reinforcement of individual activities that address different modes of learning. In some embodiments, one or more activities in the plurality of activities are available in a language other than English.

Embodiments of the interactive educational environment disclosed herein are designed to engage and retain children aged about 1 to about 10. Moreover, the subjects and learning activities are selected to be appropriate for children of that age range. However, it will be understood by those of skill in the art that children learn at different paces and at reach developmental milestones at different ages. Therefore, the ages 1 and 10 are approximate and used herein to mark the approximate age extremes of the intended audience of children.

### Digital Processing Device

The educational system disclosed herein includes a digital processing device. The digital processing device includes one or more hardware central processing units (CPU) that carry out the device's functions. The digital processing device further comprises an operating system configured to perform executable instructions, a memory device, a display, a sound output device, and an input device. In some embodiments, the digital processing device is connected to the Internet such that it accesses the World Wide Web. In other embodiments, the digital processing device is connected to an intranet. In other embodiments, the digital processing device is connected to a data storage device.

The digital processing device includes an operating system configured to perform executable instructions. The operating system is, for example, software, including programs and data, which manages the device's hardware and provides services for execution of applications. Those of skill in the art will recognize that suitable personal computer operating systems include, by way of non-limiting examples, Microsoft® Windows®, Apple® Mac OS X®, UNIX®, and UNIX-like operating systems such as GNU/Linux®. In some embodiments, the operating system is provided by cloud computing. Those of skill in the art will also recognize that suitable mobile smart phone operating systems include, by way of non-limiting examples, Nokia® Symbian® OS, Apple® iOS®, Research In Motion® BlackBerry OS®, Google® Android®, Microsoft® Windows Phone® OS, Microsoft® Windows Mobile® OS, Linux®, and Palm® WebOS®.

The digital processing device includes a memory device. The memory is one or more physical apparatus used to store data or programs on a temporary or permanent basis. In some embodiments, the memory is volatile and requires power to maintain stored information. In some embodiments, the memory is non-volatile and retains stored information when the digital processing device is not powered.

The digital processing device includes a display to send visual information to the child. In some embodiments, the display is a cathode ray tube (CRT). In some embodiments, the display is a liquid crystal display (LCD). In further embodiments, the display is a thin film transistor liquid crystal display (TFT-LCD). In some embodiments, the display is a plasma display. In other embodiments, the display is a video projector. In still further embodiments, the display is a combination of devices such as those disclosed herein.

The digital processing device includes a sound output device to send auditory information to the child. In some embodiments, the sound output device is a pair of headphones, earphones, or ear buds. In some embodiments, the sound output device is an electro-acoustic transducer or loudspeaker. In further embodiments, the sound output device is a flat panel loudspeaker, a ribbon magnetic loudspeaker, or a bending wave loudspeaker. In other embodiments, the sound output device is a piezoelectric speaker. In still further embodiments, the sound output device is a combination of devices such as those disclosed herein.

The digital processing device includes an input device to receive information from the child. In some embodiments, the input device is a keyboard. In some embodiments, the input device is a pointing device including, by way of non-limiting examples, a mouse, trackball, track pad, joystick, game controller, or stylus. In some embodiments, the input device is a touch screen or a multi-touch screen. In other embodiments, the input device is a microphone to capture voice or other sound input. In other embodiments, the input device is a video camera to capture motion or visual input. In still further embodiments, the input device is a combination of devices such as those disclosed herein.

In accordance with the description herein, suitable digital processing devices include, by way of non-limiting examples, desktop computers, laptop computers, notebook computers, net book computers, set top computers, handheld computers, Internet appliances, mobile smart phones, tablet computers, and video game consoles. Those of skill in the art will recognize that many Internet connected mobile phones are suitable for use in the system described herein. Suitable tablet computers include those with booklet, slate, and convertible configurations, known to those of skill in the art.

### Visual and Audio Content

The educational system disclosed herein includes visual and audio content that creates an educational environment. In some embodiments, the visual and audio content is delivered to the digital processing system via the Internet. In other embodiments, the visual and audio content is delivered to the digital processing system via an intranet. In still other embodiments, the visual and audio content is delivered to the digital processing system via one or more data storage devices including, by way of non-limiting examples, CD-ROMs, DVDs, flash memory devices, magnetic disk drives, and optical disk drives.

In some embodiments, the visual and audio content provided to the digital processing device is at least partially stored in the memory of the digital processing device. In further embodiments, the visual and audio content is progressively downloaded and is transferred from a server such that the child may begin playback of the media once a buffer of the content of a specified size is available to the digital processing device, but before the download is complete.

In view of the disclosure provided herein, the visual and audio content is created by techniques known to those of skill in the art using machines, software, and languages known to the art. Those of skill in the art will recognize that several digital multimedia formats are suitable including, by way of non-limiting examples, Flash®, QuickTime®, Real Media®, Windows Media®, Silverlight®, Java™, HTML 5, XHTML 5, Unity®, Audio Video Interleave (AVI), and Moving Pictures Expert Group (MPEG).

The visual and audio content provided to the digital processing device includes, by way of non-limiting examples, text, images, video, audio, motion, interactivity, and animation. The visual and audio content creates an immersive and interactive educational environment that includes a GUI. The GUI allows the child to interact with the immersive and interactive educational environment through text, hyperlinks, graphical icons and other visual elements, manipulation of graphical elements, auditory elements, and motion elements.

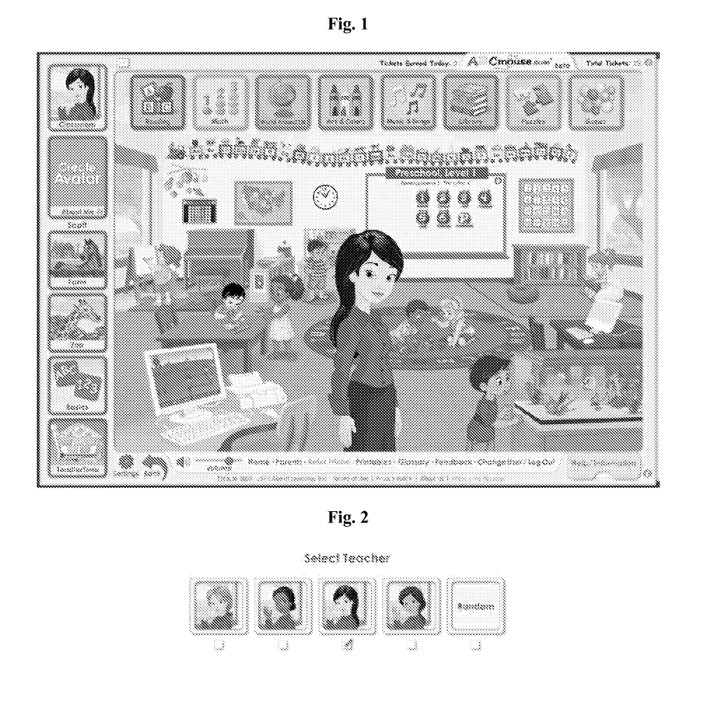

Referring to FIG. 1, in some embodiments the educational system includes a top-level GUI characterized by representing a classroom environment. In some embodiments, the classroom environment is a preschool classroom environment. In other embodiments, the classroom environment is a grade school, middle school, or junior high school classroom environment. In further embodiments, the classroom environment further includes a representation of an instructor.

Referring to FIG. 2, in still further embodiments, the child or a mentor to the child has the option to customize the appearance of the instructor. In some embodiments the child or a mentor to the child has the option to customize features of the instructor including, by way of non-limiting examples, gender, race, ethnicity, culture, age, size, or clothing in order to provide a representation familiar to the child.

In some embodiments, the educational system includes a top-level GUI characterized by representing other metaphors retentive of a child aged about 1 to 10 including, by way of non-limiting examples, personal settings, community settings, natural settings, academic settings, entertainment settings, retail settings, and professional settings. In some embodiments, personal settings include, by way of non-limiting examples, bedrooms and backyards. In some embodiments, community settings include, by way of non-limiting examples, cities, towns, playgrounds, and school busses. In some embodiments, natural settings include, by way of non-limiting examples, zoos, farms, parks, beaches, mountains, deserts, oceans, lakes, jungles, tunnels, caves, undersea environments, arctic and Antarctic environments, extraterrestrial environments, and gardens. In some embodiments, academic settings include, by way of non-limiting examples, campuses, scientific laboratories, art studios, music conservatories, computer laboratories, observatories, planetariums, and libraries. In some embodiments, entertainment settings include, by way of non-limiting examples, movies, plays, puppet shows, sporting events, amusement parks, carnivals, and theme parks. In some embodiments, retail settings include, by way of non-limiting examples, arcades, pet stores, shopping malls, other stores, and markets. In some embodiments, professional settings include, by way of non-limiting examples, kitchens, garages, machine shops, wood working shops, metal working shops, medical facilities.

### Subjects

The educational system disclosed herein includes at least three subjects appropriate for the child. A subject is a category of learning that a student has the option to undertake; the subjects offered by educational institutions typically include language arts, mathematics, social studies, science, music and other performing arts, visual arts, additional languages, health, fitness and sports, and information technology. In some embodiments, subjects comprise topics addressing one category of learning. In other embodiments, subjects comprise interdisciplinary topics addressing more than one category of learning.

In some embodiments, the subjects include one or more basic subjects appropriate for children aged about 1 to 10 including, by way of non-limiting examples, reading and mathematics. In further embodiments, the subjects include one or more basic topics including, by way of non-limiting examples, letters, phonics, word families, sight words, numbers, and shapes.

In some embodiments, the subjects include one or more preschool subjects appropriate for children aged about 1 to 10 including, by way of non-limiting examples, language arts, mathematics, social studies, science, music, art, and additional languages. In further embodiments, the subjects include one or more preschool topics including, by way of non-limiting examples, citizenship, colors, computer skills, drawing, ethics, geography, music, physical education, poetry, reading, sign language, Spanish, spelling, and U.S. history.

In some embodiments, the subjects include one or more grade school subjects appropriate for children aged about 1 to 10 including, by way of non-limiting examples, language arts, mathematics, social studies, science, music and other performing arts, visual arts, additional languages, health, fitness and sports, and information technology. In further embodiments, the subjects include one or more grade school topics including, by way of non-limiting examples, biology, chemistry, citizenship, composition, computer skills, drawing, earth science, ethics, geography, grammar, physical education, poetry, pre-algebra, reading, sign language, spelling, U.S. government, U.S. history, and writing.

In some embodiments, the subjects include one or more middle school subjects appropriate for children aged about 1 to 10 including, by way of non-limiting examples, language arts, mathematics, social studies, science, music and other performing arts, visual arts, additional languages, health, fitness and sports, and information technology. In further embodiments, the subjects include one or more middle school topics including, by way of non-limiting examples, algebra, American literature, biology, chemistry, composition, computer skills, drawing, earth science, ethics, geography, geometry, grammar, journalism, photography, physical education, poetry, pre-algebra, reading, spelling, U.S. government, U.S. history, world history, and writing.

In some embodiments, the subjects include one or more language arts topics appropriate for children aged about 1 to 10 including, by way of non-limiting examples, phonics, letters, letter sounds, letter pairs, sight words, reading, vocabulary, spelling, grammar, writing, composition, public speaking, literature, and poetry.

In some embodiments, the subjects include one or more mathematics topics appropriate for children aged about 1 to 10 including, by way of non-limiting examples, algebra, geometry, probability, statistics, and logic.

In some embodiments, the subjects include one or more social studies topics appropriate for children aged about 1 to 10 including, by way of non-limiting examples, U.S. Constitution, U.S. government, U.S. presidents, U.S. history, world leaders, world history, geography, economics, archaeology, sociology, communication, and psychology.

In some embodiments, the subjects include one or more science topics appropriate for children aged about 1 to 10 including, by way of non-limiting examples, biology, ecology, meteorology, oceanography, marine biology, botany, anatomy, zoology, chemistry, earth science, and astronomy.

In some embodiments, the subjects include one or more arts topics appropriate for children aged about 1 to 10 including, by way of non-limiting examples, writing, composition, poetry, art, music, drawing, painting, and dance.

In some embodiments, the subjects include one or more heath, sports, and fitness topics appropriate for children aged about 1 to 10 including, by way of non-limiting examples, health, nutrition, and physical education.

In some embodiments, the subjects include one or more information technology topics appropriate for children aged about 1 to 10 including, by way of non-limiting examples, computer skills and Internet safety.

The educational system disclosed herein includes at least three subjects each comprising a plurality of levels of learning. In some embodiments, a level of learning comprises educational topics and activities appropriate for a particular developmental stage of a child. In some embodiments, a level of learning comprises educational topics and activities appropriate for a particular skill level of a child. In some embodiments, a level of learning comprises educational topics and activities appropriate for a particular educational objective. In other embodiments, a level of learning comprises educational topics and activities appropriate for a particular test or certification. In some embodiments, each subject comprises three, four, five, six, seven, eight, nine, ten, eleven, twelve, or more levels of learning. In a particular embodiment, each subject comprises six levels of learning.

### Learning Activities

The educational system disclosed herein includes a plurality of activities associated with each subject, of which there are at least three. The plurality of activities teaches toward one or more educational objectives in one or more subjects. Additionally, the plurality of activities is substantially free of activities not teaching toward one or more educational objectives in a subject. In some embodiments, the activities are interconnected by an instructional plan designed to accomplish one or more specific educational objectives through the mutual reinforcement of individual activities that address different modes of learning. In some embodiments, an instructional plan interconnects two or more activities associated with a subject in such a way that understanding is built progressively with one or more activities adding to the educational content of one or more previous activities. In further embodiments, an instructional plan is conceived by an instructional designer. In other embodiments, an instructional plan is conceived by a mentor to the child. In some embodiments, the plurality of activities includes one or more activities with content unique to the educational system and not available elsewhere. In further embodiments, the unique content includes, by way of non-limiting examples, images, video, animation, game formats, text, words of a stories, lyrics of songs, spoken word audio, sound effects, and music.

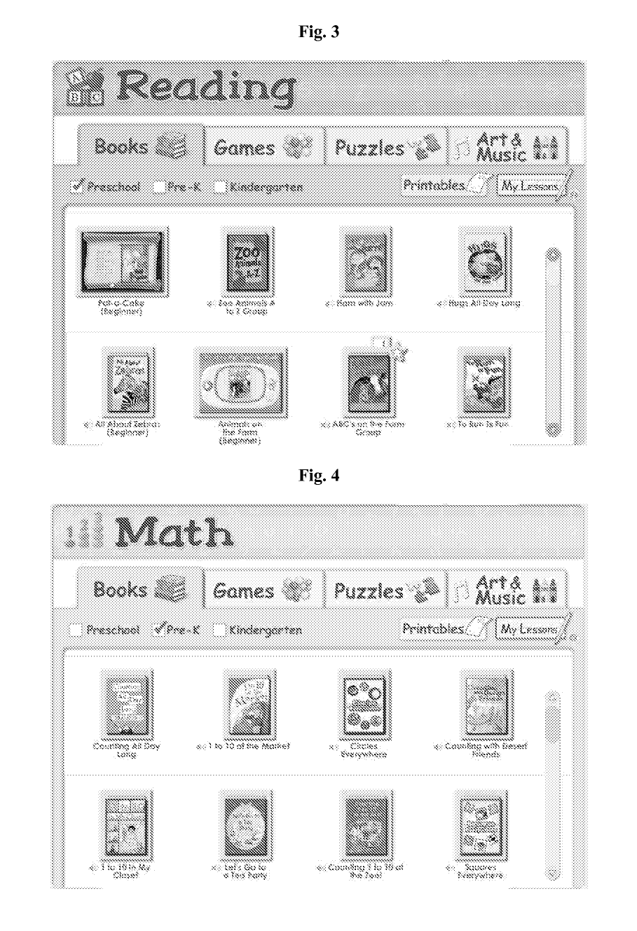

Referring to FIG. 3, in some embodiments, the child has the option to access activities associated with reading from a collection of reading-related activities. In further embodiments, the child has the option to sort the reading-related activities by activity type. In still further embodiments, the child has the option to selectively make appropriate reading-related activities available in the collection based on each activity's association with one or more levels of learning. In one particular embodiment, the child has the option to access, view, and sort reading-related activities by activity type such as books, games, puzzles, art and music, and printable activities. In some embodiments, the child has the option to selectively make appropriate activities available in the collection based on each activity's association with levels of learning such as preschool, pre-K, kindergarten, first grade, second grade, third grade, fourth grade, fifth grade, and sixth grade. In one particular embodiment, the child has the option to selectively make appropriate activities available in the collection based on each activity's association with levels of learning such as preschool, pre-K, and kindergarten.

Referring to FIG. 4, in some embodiments, the child has the option to access activities associated with the subject of math from a collection of math-related activities. In further embodiments, the child has the option to sort the math-related activities by activity type. In still further embodiments, the child has the option to selectively make appropriate math-related activities available in the collection based on each activity's association with one or more levels of learning. In one particular embodiment, the child has the option to access, view, and sort math-related activities by activity type such as books, games, puzzles, art and music, and printable activities. In one particular embodiment, the child has the option to selectively make appropriate activities available in the collection based on each activity's association with levels of learning such as preschool, pre-K, kindergarten, first grade, second grade, third grade, fourth grade, fifth grade, and sixth grade. In one particular embodiment, the child has the option to selectively make appropriate activities available in the collection based on each activity's association with levels of learning such as preschool, pre-K, and kindergarten.

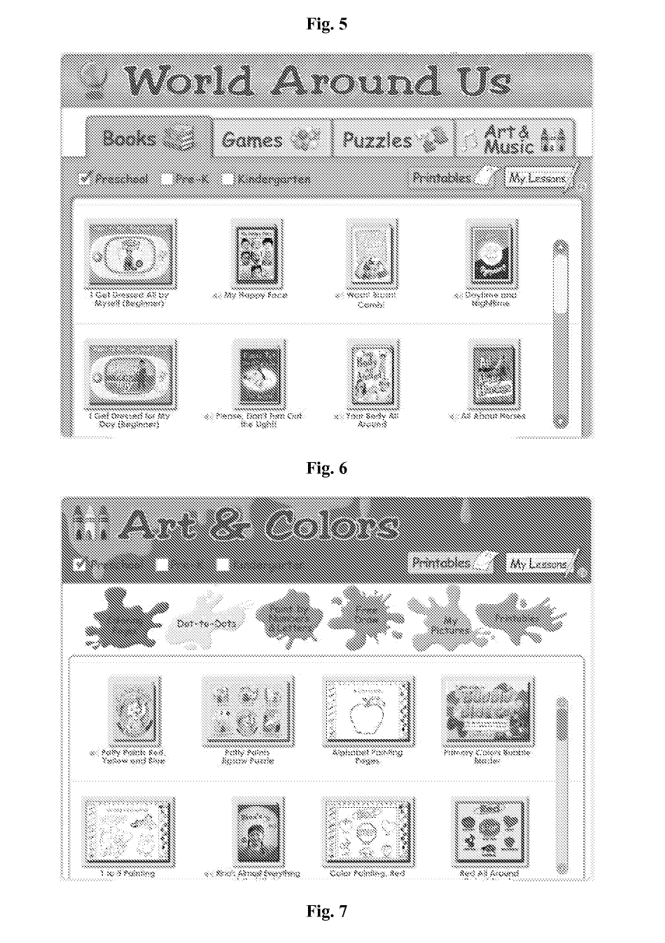

Referring to FIG. 5, in some embodiments, the child has the option to access activities associated with the subjects of science and social studies (“World Around Us”) from a collection of science and social studies-related activities. In further embodiments, the child has the option to sort the science and social studies-related activities by activity type. In still further embodiments, the child has the option to selectively make appropriate science and social studies-related activities available in the collection based on each activity's association with one or more levels of learning. In one particular embodiment, the child has the option to access, view, and sort science and social studies-related activities by activity type such as books, games, puzzles, art and music, and printable activities. In one particular embodiment, the child has the option to selectively make appropriate activities available in the collection based on each activity's association with levels of learning such as preschool, pre-K, kindergarten, first grade, second grade, third grade, fourth grade, fifth grade, and sixth grade. In one particular embodiment, the child has the option to selectively make appropriate activities available in the collection based on each activity's association with levels of learning such as preschool, pre-K, and kindergarten.

Referring to FIG. 6, in some embodiments, the child has the option to access activities associated with the subjects of art and color from a collection of art and color-related activities. In further embodiments, the child has the option to sort the art and color-related activities by activity type. In still further embodiments, the child has the option to selectively make appropriate art and color-related activities available in the collection based on each activity's association with one or more levels of learning. In one particular embodiment, the child has the option to access, view, and sort art and color-related activities by activity type such as coloring, tracing, dot-to-dot, paint-by-number, paint-by-letter, paint-by-word, free draw, and printable activities. In one particular embodiment, the child has the option to selectively make appropriate activities available in the collection based on each activity's association with levels of learning such as preschool, pre-K, kindergarten, first grade, second grade, third grade, fourth grade, fifth grade, and sixth grade. In one particular embodiment, the child has the option to selectively make appropriate activities available in the collection based on each activity's association with levels of learning such as preschool, pre-K, and kindergarten.

The educational system disclosed herein includes a plurality of activities associated with each subject. The plurality of activities associated with each subject includes'a book and at least one other activity appropriate for the child. In some embodiments, activities appropriate for the child include games, puzzles, art, music, and printables.

Referring to FIG. 7, in some embodiments, the child has the option to access music activities from a collection of music activities. In further embodiments, the child has the option to sort the music activities by songs, books, puzzles, games, art activities, printables, or other music activities. In some embodiments, music activities include one or more interactive musical instruments including, by way of non-limiting examples, accordion, bagpipe, banjo, bass, bassoon, bells, bugle, cello, clarinet, didgeridoo, drums, euphonium, fiddle, flute, French horn, guitar, harmonica, harp, harpsichord, oboe, piccolo, pipe organ, recorder, saxophone, sousaphone, trombone, trumpet, tuba, ukulele, viola, violin, and whistle. In further embodiments, the child has the option to play notes or chords on an interactive instrument by interacting with the representation of the instrument. In still further embodiments, the child has the option to trigger the instrument to play a tune. In one particular example, the music activities include an interactive piano.

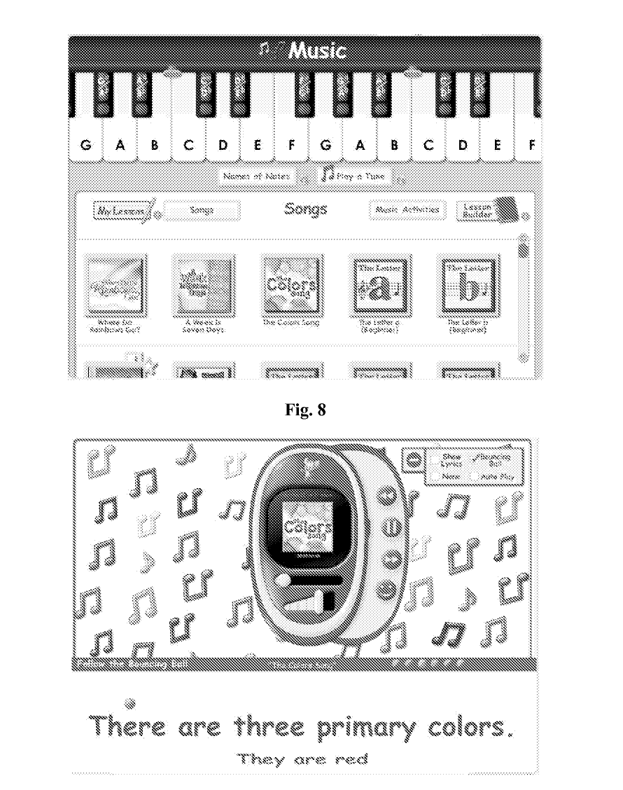

Referring to FIG. 8, in some embodiments, one or more music activities are songs. In some embodiments, songs include text of the lyrics and audio of the lyrics sung. In further embodiments, songs include an optional bouncing ball animation over text of the lyrics corresponding to audio of the lyrics sung. In some embodiments, the child experiences songs through an interactive virtual audio player. In further embodiments, the audio player displays the name of the song. In further embodiments, the audio player offers controls including, by way of non-limiting examples, a progress indicator, a volume control, and play/pause controls. In still further embodiments, the audio player includes images, video, and/or animation corresponding to the lyrics. In some embodiments, songs include a means to reduce or remove the voice track and a means to record singing of the lyrics using the digital processing device of the system. In further embodiments, songs include a means for children and their mentors to share songs with personalized signing with other users of the educational system.

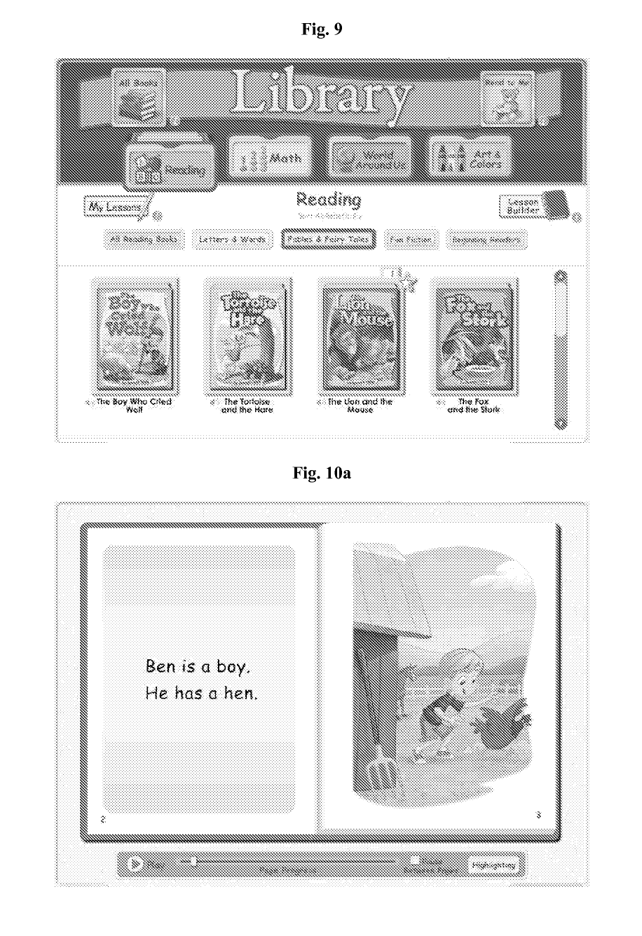

Referring to FIG. 9, in some embodiments, the child has the option to access reading activities from a collection of reading activities represented as books in a library. In some embodiments, the child has the option to sort the books by subject. In some embodiments, the child has the option to sort the books by type of story including, by way of non-limiting examples, letter stories, word stories, number stories, science stories, fables, fairy tales, fiction, mysteries, science fiction, historical stories, holiday stories, choose your own adventure stories, and beginning reader stories. In one particular embodiment, the child has the option to sort the books by subjects including, reading, math, science and social studies (“World Around Us”), and art and colors and has the option to sort the books by type of story including all books, letters and words, fables and fairy tales, fun fiction, and beginning readers.

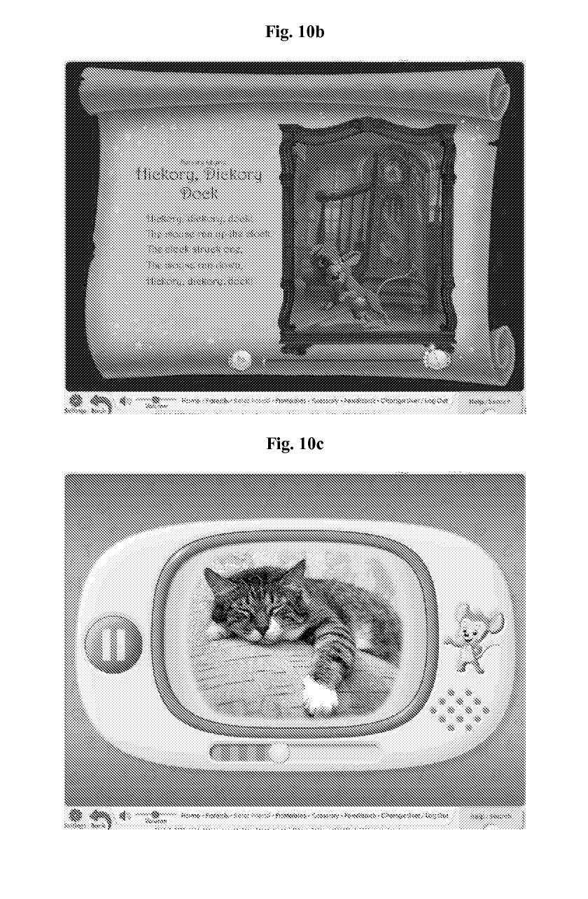

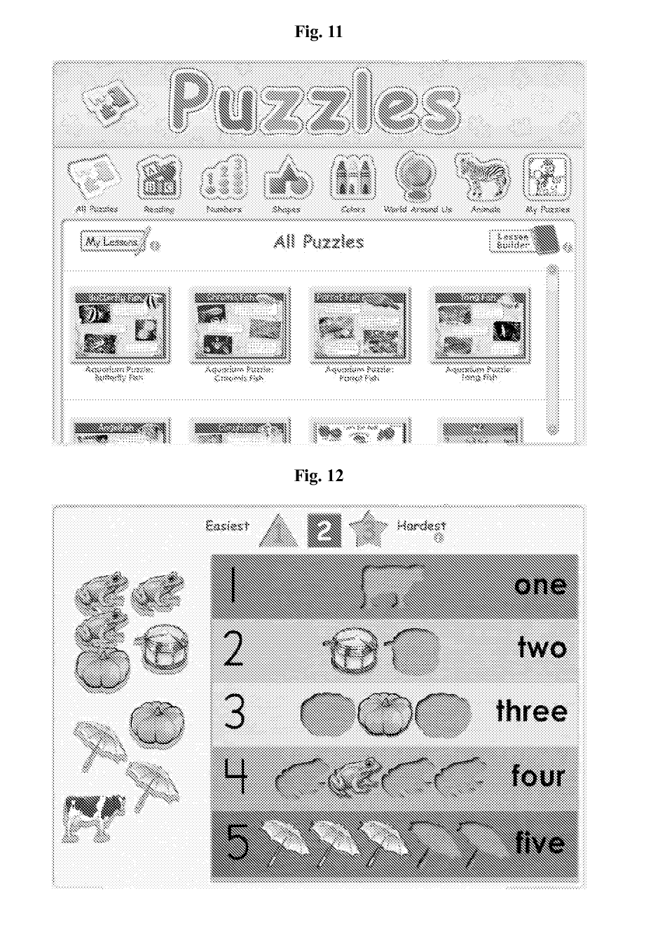

Referring to FIG. 10a, in some embodiments, one or more reading activities are books. In some embodiments, books include text of the story and audio of the story read. In further embodiments, books include images associated with the story. In still further embodiments, the books include video and/or animation associated with the story. In some embodiments, the child experiences books through a multipage, interactive virtual book. In further embodiments, a multipage, interactive virtual book includes an animated page flipping format. In further embodiments, the interactive virtual book offers controls including, by way of non-limiting examples, an automatic page flipping mode, a manual page flipping mode, a progress indicator, play/pause controls, and optionally, highlighting of words in the book corresponding to the audio. In further embodiments, books include a means to record voice narration of the story using the digital processing device of the system. In still further embodiments, books include a means for children and their mentors to share books with personalized narration with other users of the educational system.

Referring to FIG. 10b, in some embodiments, one or more reading activities are single-page, interactive virtual books adapted for nursery rhymes, short poems, and short stories. In further embodiments, single-page, interactive virtual books comprise a single page with text and images, audio of the book read, play/pause controls, a progress indicator, and optionally, highlighting of words in the book corresponding to the audio. In some embodiments, single-page, interactive virtual books further comprise video or animation.

Referring to FIG. 10c, in some embodiments, one or more reading activities are “Read-to-Me” virtual books adapted for use by toddlers. In further embodiments, “Read-to-Me” virtual books comprise audio of the book read, images corresponding to the audio, play/pause controls, and a progress indicator. In some embodiments, “Read-to-Me” virtual books further comprise video or animation.

Referring to FIG. 11, in some embodiments, the child has the option to access puzzle activities from a collection of puzzles. In further embodiments, the child has the option to sort the puzzles by subject. In further embodiments, the child has the option to sort the puzzles by type of puzzle. In one particular embodiment, the child has the option to sort the puzzles by subjects including, all puzzles, reading, numbers, shapes, colors, science and social studies (“World Around Us”), and animals. In one particular embodiment, the child has the option to sort the puzzles by type including, cutout puzzles and jigsaw puzzles. In some embodiments, puzzles also include, by way of non-limiting examples, crosswords, Sudoku, and anagrams.

Referring to FIG. 12, in some embodiments, one or more puzzles are cutout puzzles. In some embodiments, a cutout puzzle invites the child to fit shaped puzzle pieces into cutouts in a puzzle board to reinforce an educational message. In further embodiments, the puzzle includes a plurality of skill levels. In still further embodiments, the skill level is related to the number of pieces that the child must fit into the board to complete the puzzle. In some embodiments, the puzzle includes audio elements to, by way of non-limiting examples, encourage the child, instruct the child, reward the child, identify the educational objectives of the puzzle, demonstrate an educational message in the puzzle, and identify the title of the puzzle. In a particular embodiment, the puzzle identifies the puzzle pieces with spoken word audio when they are moved.

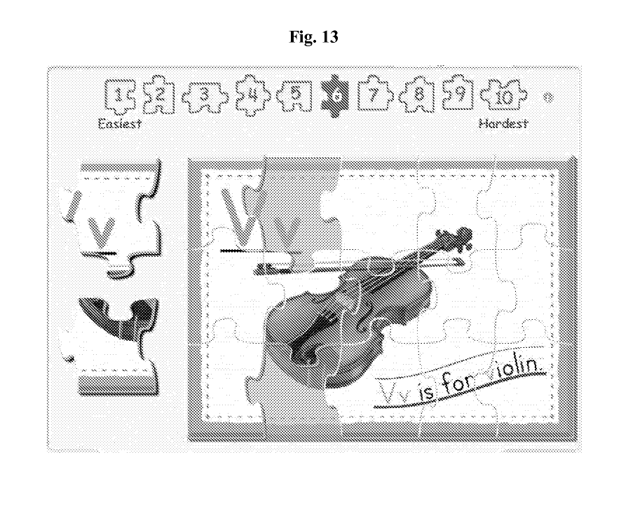

Referring to FIG. 13, in some embodiments, one or more puzzles are jigsaw puzzles. In some embodiments, a jigsaw puzzle invites the child to fit shaped puzzle pieces together to complete an image that reinforces an educational message. In further embodiments, the puzzle includes a plurality of skill levels. In still further embodiments, the skill level is related to the number of pieces that the child must fit into the board to complete the puzzle In some embodiments, the puzzle includes audio elements to, by way of non-limiting examples, encourage the child, instruct the child, reward the child, identify the educational objectives of the puzzle, demonstrate an educational message in the puzzle, and identify the title of the puzzle. In a particular embodiment, the puzzle identifies a letter with spoken word audio and uses the letter in a sentence upon completion.

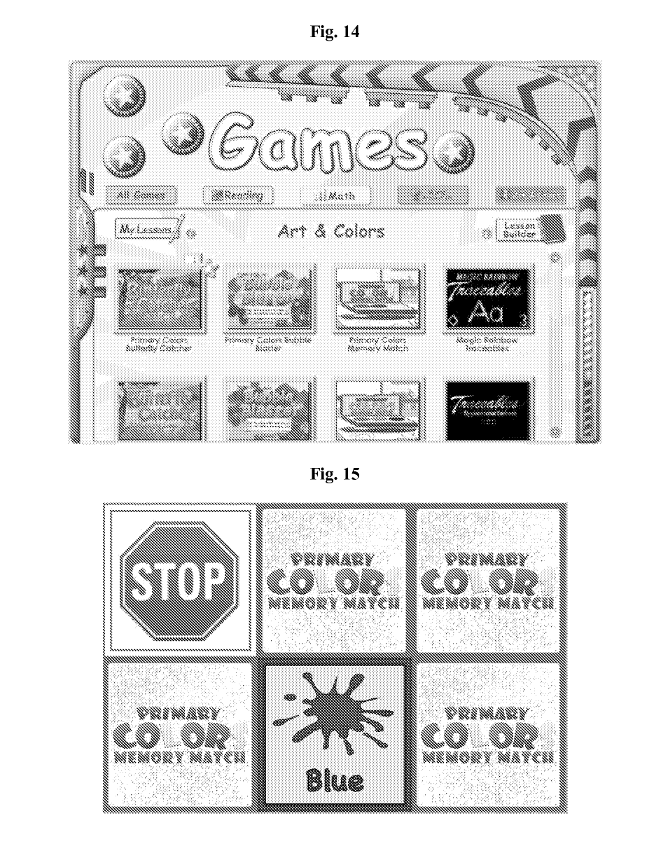

Referring to FIG. 14, in some embodiments, the child has the option to access game activities from a collection of games. In further embodiments, the child has the option to sort the games by subject. In one particular embodiment, the child has the option to sort the games by subjects including, all games, reading, numbers, science and social studies (“World Around Us”), and art and colors.

Referring to FIG. 15, in some embodiments, one or more games are in a memory matching game format. In some embodiments, a memory matching game invites the child to interact with the game to flip pairs of cards to match words with images to reinforce an educational message. In other embodiments, games are designed to increase skills in academic topics including, by way of non-limiting examples, letter recognition, letter sounds, letter tracing, letter matching, letter fill-in, word recognition, word sounds, word tracing, spelling, number recognition, counting, number tracing, number matching, number fill-in, more or less, shape tracing, shape recognition, primary color recognition, secondary color recognition, color matching, and animal recognition.

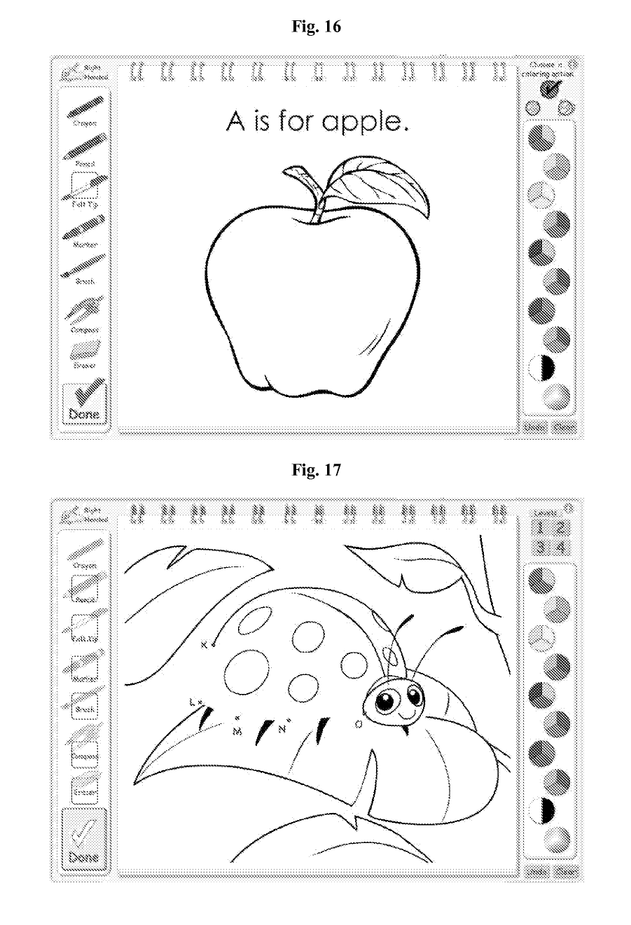

Referring to FIG. 16, in some embodiments, one or more art activities are coloring pages. In some embodiments, a coloring page invites the child to select tools and colors to fill in an image in order to reinforce an educational message. In further embodiments, the tools include, by way of non-limiting examples, crayons, pencils, felt tip pens, markers, brushes, compasses, and erasers. In still further embodiments, the child may select colors from among a color palette arranged to convey educational messages about shade, color, hue, and primary versus secondary colors.

Referring to FIG. 17, in some embodiments, one or more art activities are dot-to-dots. In some embodiments, a dot-to-dot invites the child to connect dots to complete an image based on a sequence of letters or numbers. In some embodiments, a dot-to-dot subsequently invites the child to select tools and colors to fill in the image in order to reinforce an educational message. In further embodiments, the tools include, by way of non-limiting examples, crayons, pencils, felt tip pens, markers, brushes, compasses, and erasers. In still further embodiments, the child may select colors from among a color palette arranged to convey educational messages about shade, color, hue, and primary versus secondary colors. In further embodiments, the dot-to-dot includes a plurality of skill levels. In still further embodiments, the skill level is related to the number of dots that the child must connect to complete the image.

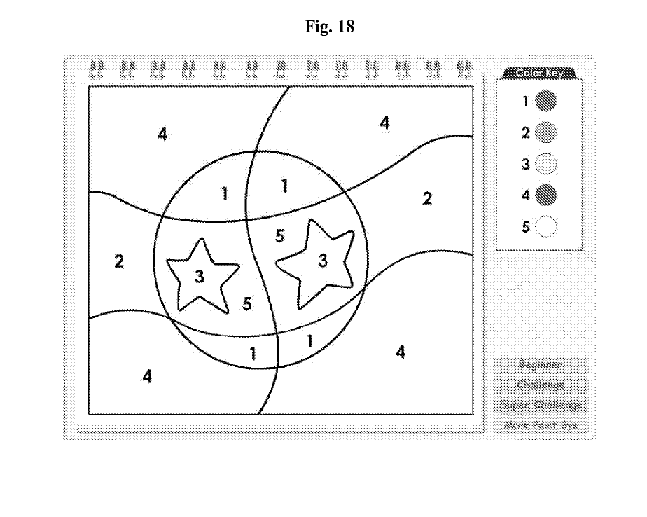

Referring to FIG. 18, in some embodiments, one or more art activities are paint-by-numbers. In some embodiments, paint-by-number invites the child to match numbers to a numbered color palette to fill in an image in order to reinforce an educational message. In further embodiments, the child may select colors from among a color palette arranged to convey educational messages about shade, color, hue, and primary versus secondary colors. In further embodiments, the paint-by-number includes a plurality of skill levels. In still further embodiments, the skill level is related to the number of sections that the child must fill in to complete the image.

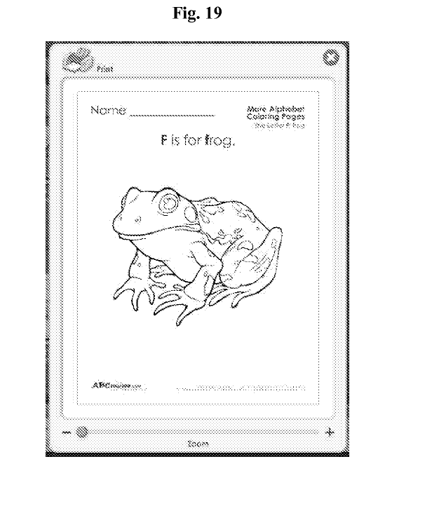

Referring to FIG. 19, in some embodiments, one or more art activities are printable activities. In some embodiments, a printable invites the child to print a worksheet and subsequently, color, draw, write, or trace on it in order to reinforce an educational message. In some embodiments, one or more printable activities include, by way of non-limiting examples, coloring, drawing, writing, tracing, connect-the-dots, paint-by-number, paint-by-letter, or paint-by-word.

In some embodiments, the educational system disclosed herein includes one or more themed sub-level GUIs. In further embodiments, sub-level GUIs provide access to activities with a common theme that teach toward one or more educational objectives in a subject. In further embodiments, sub-level GUIs provide access to activities with a common theme that teach toward one or more educational objectives in multiple subjects. In still further embodiments, one or more sub-level GUIs are themed, by way of non-limiting examples, as libraries, laboratories, medical facilities, cities, sporting events, school buses, amusement parks, carnivals, shopping malls, markets, kitchens, garages, museums, playgrounds, gardens, deserts, mountains, lakes, undersea environments, extraterrestrial environments, and arctic or Antarctic environments.

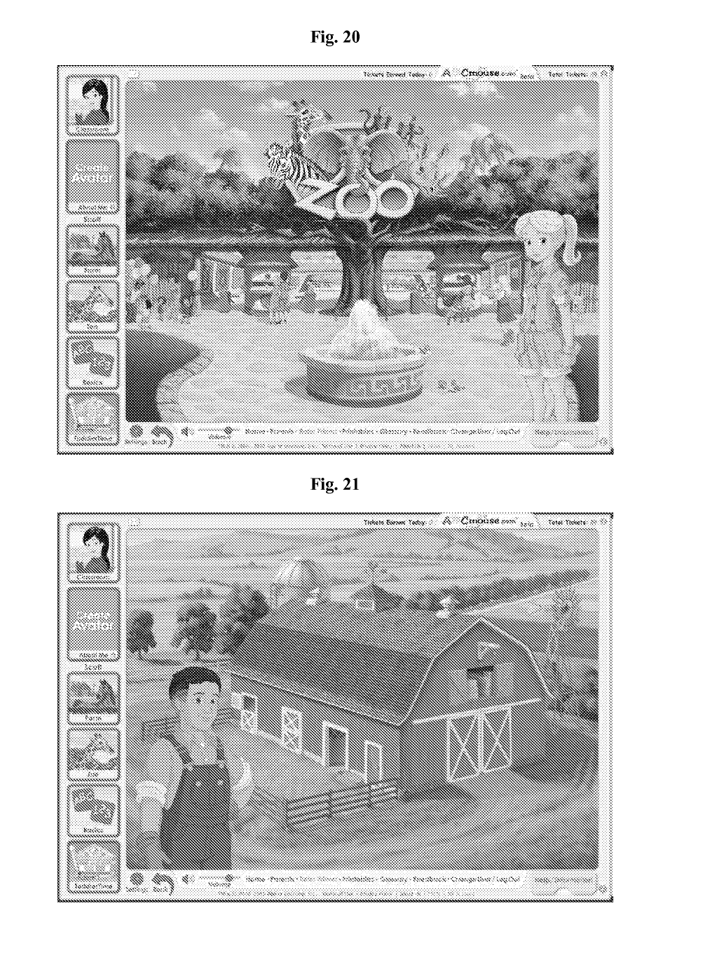

Referring to FIG. 20, in some embodiments, the educational system disclosed herein includes a zoo-themed sub-level GUI. In further embodiments, the zoo-themed sub-level GUI provides access to zoo-related activities that teach toward one or more educational objectives in any subject. In additional embodiments, the zoo-themed sub-level GUI provides access to activities such as books, games, art, and puzzles related to animals such as penguins, seals, gorillas, monkeys, lions, pandas, birds, anteaters, ostriches, flamingos, zebras, giraffes, camels, impalas, and elephants. In some embodiments, the zoo-themed sub-level GUI provides access to animated wild animals.

Referring to FIG. 21, in some embodiments, the educational system disclosed herein includes a farm-themed sub-level GUI. In further embodiments, the farm-themed sub-level GUI provides access to farm-related activities that teach toward one or more educational objectives in any subject. In still further embodiments, the farm-themed sub-level GUI provides access to activities related to domesticated animals. In additional embodiments, the farm-themed sub-level GUI provides access to activities such as books, games, art, and puzzles related to animals such as horses, chickens, cows, and sheep. In some embodiments, the farm-themed sub-level GUI provides access to animated domesticated animals.

The educational system disclosed herein includes one or more activities that comprise a plurality of skill levels. A skill level is related to the difficulty of the activity and the actions required to complete the activity. In some embodiments, the educational system automatically determines the appropriate skill level for a particular child based on, by way of non-limiting examples, age, level of subject, performance in previously completed activities, or the number of times the child has completed the activity. In some embodiments, the child selects a skill level before an activity. In some embodiments, the child selects a skill level during an activity. In some embodiments, one or more activities includes two, three, four, five, six, seven, eight, nine, ten, eleven, twelve, or more skill levels.

In some embodiments, one or more activities are available in a language other than English in order to facilitate the education of non-English speaking children. In some embodiments, one or more activities are available in a language other than English in order to develop the ability to communicate in a different language. In further embodiments, one or more activities are available in one or more languages including, by way of non-limiting examples, Spanish, Italian, Portuguese, French, Dutch, Polish, German, Russian, Ukrainian, Mandarin, Wu, Cantonese, Hindi, Punjabi, Bengali, Marathi, Urdu, Arabic, Turkish, Tamil, Farsi, Japanese, Korean, Vietnamese, Thai, Burmese, Malay, Telugu, and Javanese.

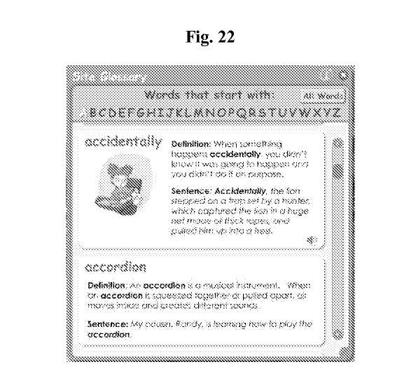

Referring to FIG. 22, in some embodiments, the educational system disclosed herein includes a glossary of words used in one or more activities. In further embodiments, the glossary comprises one or more entries, wherein each entry comprises a word, a definition of the word, and the word used in a sentence. In still further embodiments, the entries further comprise audio of the word and its definition read. In still further embodiments, the entries further comprise an image associated with the word to facilitate understanding of the word and its definition. In some embodiments, the glossary includes video or animation associated with the word to facilitate understanding of the word and its definition. In some embodiments, the glossary includes parallel entries for one or more words in a language other than English. In additional embodiments, the glossary is contextual, wherein the entries comprise only those words used in the current activity.

In some embodiments, the educational environment further comprises an encyclopedia, a dictionary, and/or a thesaurus.

### Monitoring Progress of the Child

The educational system disclosed herein includes a software module for monitoring the progress of the child in each of the subjects. In view of the disclosure provided herein, the software module is created by techniques known to those of skill in the art using machines, software, and languages known to the art. In some embodiments, the software module allows both the child and a mentor to the child to independently monitor the progress of the child in each subject and each level of learning within each subject. In further embodiments, the software module further includes progress displays, also referred to as progress reports, progress records, or progress logs. In still further embodiments, the software module includes printable reports of the child's progress.

In some embodiments, the progress displays indicate percentage completion of each subject. In some embodiments, the progress displays indicate percentage completion of one or more levels of learning within each subject. In further embodiments, the progress displays indicate completion of each activity associated with one or more subjects. In further embodiments, the progress displays indicate completion of each activity associated with one or more levels of learning within each subject.

In some embodiments, the progress displays indicate the number of times each activity has been completed. In some embodiments, the number of times each activity has been completed is represented, by way of non-limiting examples, as a number, a percentage, a color, a shape, or by an icon such as a star, checkmark, dot, or smiley face.

In some embodiments, the progress displays indicate performance via, by way of non-limiting examples, raw scores or percentages. Some embodiments might also indicate performance by metrics such as grades. In some embodiments, the progress displays indicate performance in each subject. In some embodiments, the progress displays indicate performance in one or more levels of learning within each subject. In further embodiments, the progress displays indicate performance in each activity associated with one or more subjects. In still further embodiments, the progress displays indicate performance in each activity associated with one or more levels of learning within each subject.

In some embodiments, the progress displays indicate time spent on each subject. In some embodiments, the progress displays indicate time spent on one or more levels of learning within each subject. In further embodiments, the progress displays indicate time spent on each activity associated with one or more subjects. In further embodiments, the progress displays indicate time spent on each activity associated with one or more levels of learning within each subject.

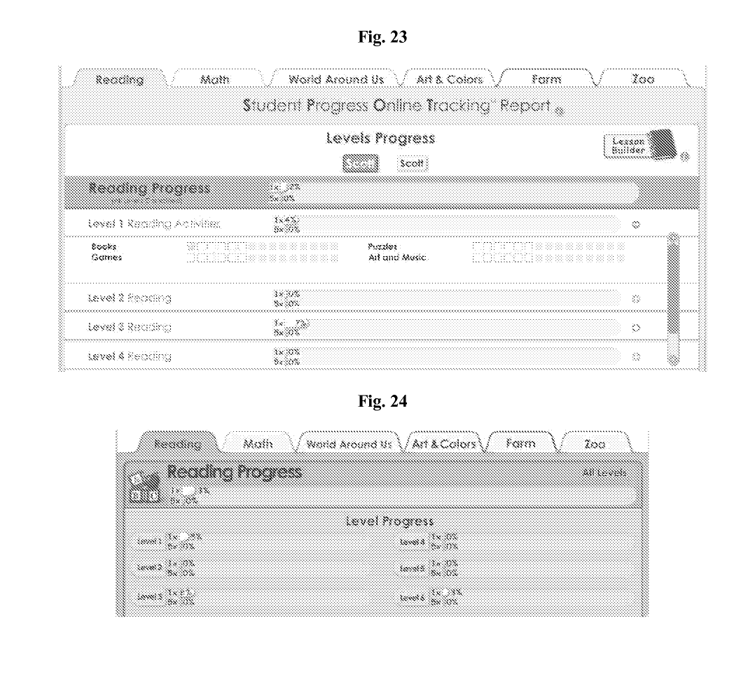

Referring to FIG. 23, in some embodiments, the software module for monitoring the progress of the child further includes a display of the child's progress for the benefit of a mentor to the child. In some embodiments, the progress displays indicate percentage completion of each subject. In some embodiments, the progress displays indicate percentage completion of one or more levels of learning within each subject. In further embodiments, the progress displays indicate completion of each activity associated with one or more subjects. In further embodiments, the progress displays indicate completion of each activity associated with one or more levels of learning within each subject. In some embodiments, the software module for monitoring the progress of the child in each of the subjects includes printable reports adapted for use by a mentor to the child. In further embodiments, the progress displays and printable reports adapted for use by a mentor are secure and cannot be accessed by the child or others.

Referring to FIG. 24, in some embodiments, the software module for monitoring the progress of the child further includes a display of the child's progress for the benefit of the child. In some embodiments, the progress displays indicate percentage completion of each subject. In some embodiments, the progress displays indicate percentage completion of one or more levels of learning within each subject. In some embodiments, the software module for monitoring the progress of the child in each of the subjects includes printable reports adapted for use by the child.

In some embodiments, the software module for monitoring the progress of the child presents a visual indicator, for the benefit of the child, that represents the percentage of activities completed within a sequence of activities. In some embodiments, the visual indicator represents the percentage of activities completed within, by way of non-limiting examples, a lesson, a subject, a level of learning within a subject, and a multi-subject level. In further embodiments, the visual indicator represents a percentage as, by way of non-limiting examples, a number, a bar chart, a pie chart, or a color.

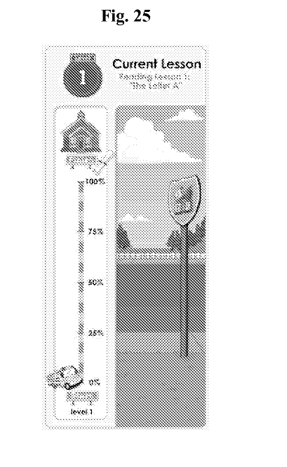

Referring to FIG. 25, in some embodiments, the visual indicator represents the percentage of activities completed within a level of learning as a bar chart.

In some embodiments, a level of learning is represented in the GUI as a linear succession. In some of these embodiments, the representation provides a visual metaphor, for the benefit of the child, that will motivate the child to complete activities in the level and will reward the child for doing so by allowing them to progress in the level. In some embodiments, the entire linear succession is not visible to the child in a single view. In some of these embodiments, a portion of the representation of a linear succession is hidden to avoid overwhelming the child with the scope of the level. In further embodiments, the child has the option to explore the linear succession in parts.

In further embodiments, lessons, comprising groups of activities, are represented as points in the linear succession. In some embodiments, lessons comprise groups of activities in the same subject. In other embodiments, lessons comprise groups of activities in more than one subject. In some embodiments, activities within a lesson are further represented as a group of selectable activity icons. In some of these embodiments, the representation displays the activities and provides access to the activities for the benefit of the child. In some embodiments, the group of selectable activity icons is represented in the GUI in a defined area to symbolize the interrelationship of the activities and their educational messages within the lesson. In still further embodiments, the current lesson, defined by completion of all activities in prior lessons in the sequence, is highlighted and identified among other points in the linear succession.

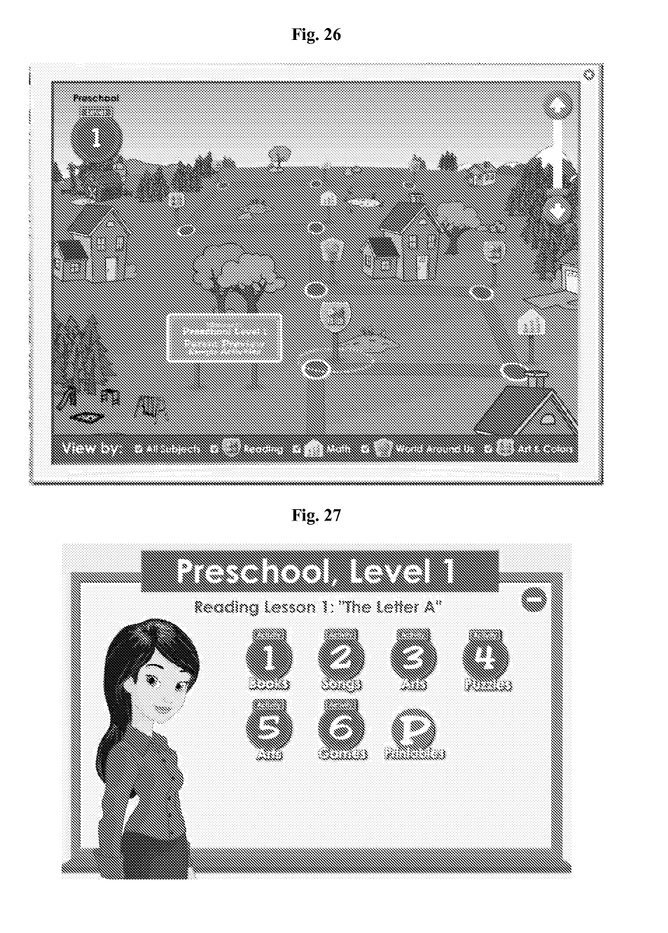

Referring to FIG. 26, in some embodiments, the linear succession is further represented as a map, path, or road and said lessons comprising groups of activities are further represented as waypoints or stops on the map, path, or road. In further embodiments, the map, path, or road is represented in a larger context including, by way of non-limiting examples, an urban environment, a rural environment, or a natural environment.

Further referring to FIG. 26, in some embodiments, the child has access to a means of optionally removing one or more categories of activities from the predetermined sequence of activities. In some embodiments, the child may remove activities associated with one or more subjects. In some embodiments, the child may remove activities of one or more types.

Referring to FIG. 27, in some embodiments, lessons are represented as a group of selectable activity icons which are further represented on a whiteboard, chalkboard, or bulletin board.

In other embodiments, the linear succession is further represented as a line graph and lessons, comprising groups of activities, are further represented as points on the line graph. In further embodiments, lessons are represented as a group of selectable activity icons which is further represented as on a graph legend.

In still other embodiments, the linear succession is further represented as a football field and lessons, comprising groups of activities, are further represented as yard markers on the football field. In further embodiments, lessons are represented as a group of selectable activity icons which is further represented as on a scoreboard.

In still other embodiments, the linear succession is further represented as a length of rainbow and lessons, comprising groups of activities, are further represented as colors within the rainbow.

In still other embodiments, the linear succession is further represented as a length of cave or rock wall and lessons, comprising groups of activities, are further represented as pictographic drawings on the cave or rock wall.

In still other embodiments, the linear succession is further represented as an auto racetrack and lessons, comprising groups of activities, are further represented as mile markers on the auto racetrack. In further embodiments, lessons are represented as a group of selectable activity icons which is further represented as on a billboard.

### Rewarding the Child

The educational system disclosed herein includes a software module for rewarding the child for completing an activity. In view of the disclosure provided herein, the software module is created by techniques known to those of skill in the art using machines, software, and languages known to the art. In some embodiments, the software module creates a virtual economy. A virtual economy is a system designed to encourage productive activity by awarding units. Anything that is visible and countable can be used as a unit. In an effective virtual economy, individuals receive units immediately after completing learning activities and the units are collected and later exchanged for a meaningful object or privilege. In further embodiments of the educational system disclosed herein, the virtual economy comprises one or more units awarded for completing an activity and one or more stores for spending awarded units on virtual items used in the educational system.

In some embodiments, units awarded for completing an activity are represented as virtual objects including, by way of non-limiting examples, coins, currency, gold bars, diamonds, jewels, or treasure. In some embodiments, units awarded for completing an activity are represented as abstractions including, by way of non-limiting examples, points, stars, hearts, smiley faces, or lighting bolts. In some embodiments, units awarded for completing an activity are represented as measures of qualities or attributes including, by way of non-limiting examples, strength, power, or life. In additional embodiments, the number of units awarded for completing an activity varies based on circumstances including, by way of non-limiting examples, performance in the activity, time spent on the activity, difficulty of the activity, or the number of times the child has completed the activity. In one embodiment, the software module for rewarding the child awards double units for completing an activity a fifth or subsequent time.

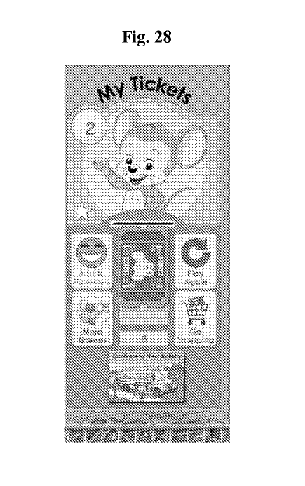

Referring to FIG. 28, in some embodiments, the units are represented as virtual tickets. In some of these embodiments, the number of tickets awarded for completing an activity varies by the level of effort or time that the activity requires. In further embodiments, the virtual tickets are represented as dispensed from a virtual machine. In still further embodiments, the virtual ticket machine displays the number of tickets awarded for the last completed activity as well as the total number of tickets collected.

In some embodiments, the software module for rewarding the child for completing an activity further includes a system for exchanging tickets. In some embodiments, tickets are exchanged to unlock or gain access to new activities or games. In some embodiments, tickets are exchanged for non-virtual merchandise. In some of these embodiments, the non-virtual merchandise includes, by way of non-limiting examples, clothing, posters, music, videos, desktop images, and ringtones. In other embodiments, tickets are exchanged for virtual items used in the educational system.

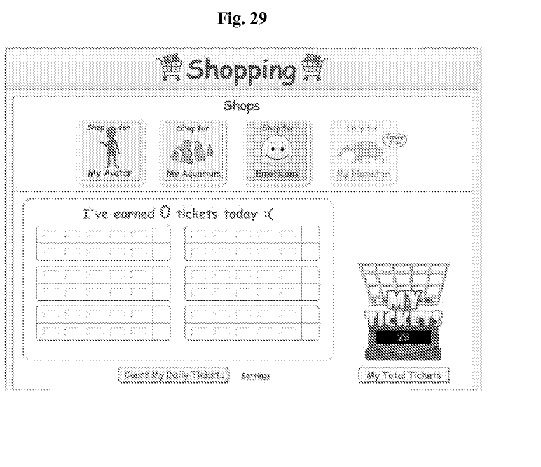

Referring to FIG. 29, in some embodiments, tickets are exchanged for virtual items used in the educational system in one or more interactive virtual stores. In some embodiments, access to one or more stores is provided via a virtual shopping center that lists open stores, displays the number of tickets the child earned that day, and the total number of tickets the child has collected. In further embodiments, the virtual items used in the educational system include, by way of non-limiting examples, items to customize an avatar, virtual pets, and emoticons, which are icons representing emotion, usually used to express mood. In additional embodiments, the virtual items used in the educational system include skins for the GUI of the educational system and themes for the GUI of the educational system.

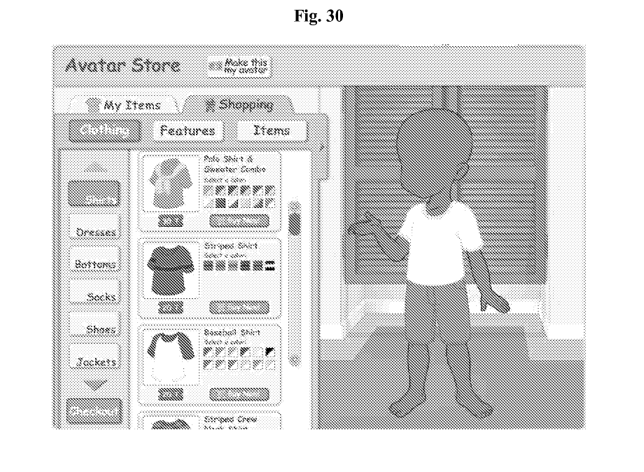

Referring to FIG. 30, in some embodiments, the avatar store allows the child to exchange awarded tickets for clothing, features, and other items to customize an avatar to represent the child in the educational environment. In further embodiments, the avatar clothing includes, by way of non- limiting examples, shirts, dresses, bottoms, socks, shoes, jackets, sweaters, and costumes. In further embodiments, the avatar features include, by way of non-limiting examples, skin tones, eyes, eye color, noses, mouths, mouth color, hair styles, and hair color. In still further embodiments, the avatar items include, by way of non-limiting examples, background scenes, glasses, and pets. In some of these embodiments, customizations to the child's avatar are demonstrated in real time as they are selected.

### Creating an Avatar to Represent the Child

The educational system disclosed herein includes a software module for creating, maintaining, and enhancing an avatar to represent the child in the educational system. In view of the disclosure provided herein, the software module is created by techniques known to those of skill in the art using machines, software, and languages known to the art. An avatar is a computer user's representation of himself/herself in a computer-based environment such as a video game, interactive website, or Internet forum. In some embodiments, the software module for creating an avatar to represent the child includes means for selecting the form of the child's avatar used in the educational system. In some embodiments, the software module for creating an avatar to represent the child includes means for selecting clothing and physical features associated with the child's avatar. In further embodiments, the means for selecting avatar clothing includes a means for selecting the color and style of each article of clothing.

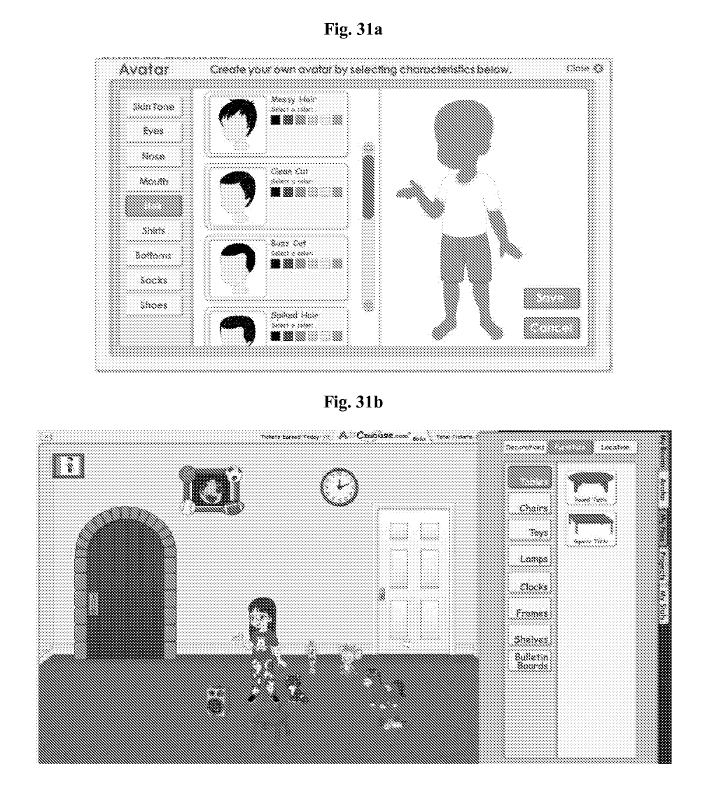

Referring to FIG. 31a, in some embodiments, the avatar is in the form of a child. In a particular embodiment, the avatar clothing includes shirts, bottoms, socks, and shoes. In a particular embodiment, the avatar physical features include skin tone, eyes, eye color, nose, mouth, mouth color, hairstyle, and hair color. In some of these embodiments, customizations to the child's avatar are demonstrated in real time as they are selected.

In further embodiments, avatar forms include, by way of non-limiting examples, a person, an animal, and an extraterrestrial organism. In further embodiments, the avatar clothing also includes, by way of non-limiting examples, dresses, skirts, jackets, coats, sweaters, suits, jewelry, scarves, gloves, pants, shorts, overalls, tank tops, swimsuits, robes, pajamas, sandals, slippers, boots, and costumes. In further embodiments, the avatar physical features include, by way of non-limiting examples, gender, height, weight, build, disabilities, ears, eyebrows, eyebrow color, handedness, shoe size, freckles, and braces.

Referring to FIG. 31b, in some embodiments, the software module for creating an avatar to represent the child includes means for creating, maintaining, and enhancing a room associated with the child's avatar used in the educational system and a means for customizing aspects of the room. In further embodiments, these aspects of the room include, by way of non-limiting examples, size, color, furnishings, art, windows, doors, lighting, music, window treatments, toys, and decorations. In still further embodiments, the child may customize the room with furniture including, by way of non-limiting examples, tables, chairs, lamps, clocks, frames, shelves, and bulletin boards.

In still further embodiments, the software module for creating an avatar to represent the child includes means for selecting animation or motion features associated with the child's avatar used in the educational system. In further embodiments, the avatar animation also includes, by way of non-limiting examples, waving, dancing, winking, and smiling.

In additional embodiments, the software module for creating an avatar to represent the child further includes means for capturing, zooming, and panning images of the child's avatar for display in the educational system. In further embodiments, the means for capturing, zooming, and panning images is represented as an interactive camera.

### Various Non-Limiting Embodiments

In some embodiments, the educational system described herein is characterized by a complete absence of third party advertising. In further embodiments, the operator of the educational system advertises their own educationally related products and services, but not those of others. In some of these embodiments, the absence of third party advertising contributes to the immersive characteristics of the educational system.

In some embodiments, the educational system described herein is characterized by a complete absence of direct links to third party websites. In further embodiments, the operator of the educational system links to their own educationally related websites, but not those of others. In some of these embodiments, the absence of direct links to third party websites contributes to the immersive characteristics of the educational system.

In some embodiments, the educational system described herein includes a software module for rating activities. In some embodiments, the child has the option to express an opinion of an activity upon completion of the activity. In some embodiments, the child has the option to express an opinion of an activity during the activity. In further embodiments, the child has the option to express an opinion of an activity on a numeric scale such as a scale from one to five. In other embodiments, the child has the option to express an opinion of an activity with an emoticon. In still other embodiments, the child has the option to express an opinion of an activity by assigning, by way of non-limiting examples, colors, stars, points, or letters to an activity.

In some embodiments, the educational system described herein includes a software module for designating favorite activities. In further embodiments, the child is allowed an opportunity to designate an activity as a favorite upon completion of the activity. In some embodiments, the child may designate an activity as a favorite during the activity. In further embodiments, the child has the option to access a library of those activities he/she has designated as favorites. In some embodiments, the child has the option to additionally access a library of those activities the educational community of children has most commonly designated as favorites.

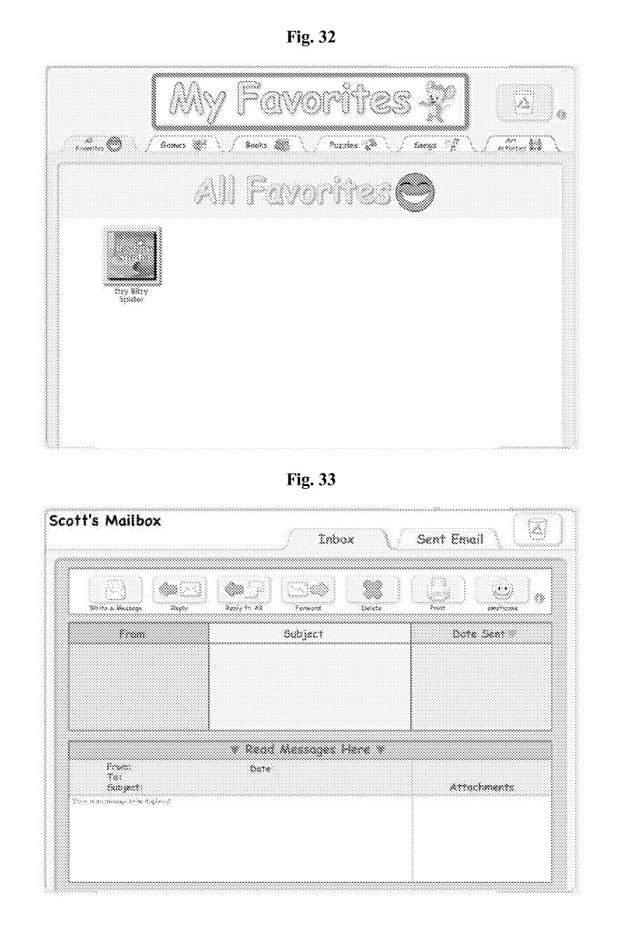

Referring to FIG. 32, in some embodiments, the child has the option to view and sort icons representing favorite activities. In some embodiments, the child has the option to view and sort favorites by type of activity. In some embodiments, the child has the option to view and sort favorites by subject. In some embodiments, the child has the option to view and sort favorites by rating given by the child or by average rating given by the educational community of children.

In some embodiments, the educational system disclosed herein includes a software module for allowing children using the system to communicate with each other. In view of the disclosure provided herein, the software module is created by techniques known to those of skill in the art using machines, software, and languages known to the art. In some embodiments, the means of communication includes Internet chat. In some embodiments, the means of communication includes intranet chat. In further embodiments, means of communication is video chat. In other embodiments, the means of communication includes email or virtual mail. In some of these embodiments, the system to communicate does not allow communication with parties outside of the educational system.

Referring to FIG. 33, in some embodiments, the educational system disclosed herein further includes a virtual mail system. In some embodiments, the virtual mail system includes an inbox and a sent mail box. In some embodiments, the virtual mail system allows authoring a new message, replying to a message, forwarding a message, deleting a message, printing a message, adding attachments to a message, and adding emoticons to a message. In further embodiments, units, such as virtual tickets, awarded in a virtual economy for completing an activity can be exchanged for emoticons that can be added to virtual mail messages to express the child's mood. In some embodiments, the virtual mail system transmits messages via the Internet. In other embodiments, the virtual mail system transmits messages via an intranet or other computer network. In some embodiments, the virtual mail system contributes to the immersive characteristics of the educational system by providing an opportunity for the child to present his/her educational work products to friends and mentors.

In some embodiments, the educational environment disclosed herein includes multiple navigational modes. In further embodiments, the navigational modes include a sequenced navigational mode, a guided navigational mode, and an independent navigational mode.

In some embodiments, the educational environment disclosed herein includes a sequenced navigational mode wherein the system presents to the child a predetermined sequence of more than one activity in one or more subjects wherein the child must complete each preceding activity in the sequence to progress to the next. In some embodiments, each step in the predetermined sequence of activities comprises either an activity or a set of alternate activities. In further embodiments, where the next step in a predetermined sequence of activities is a singular activity, the educational system presents the activity to the child. In further embodiments, where the next step in a predetermined sequence of activities is a set of alternate activities, the educational system presents one activity from the set of alternate activities to the child.

In some embodiments, the educational environment disclosed herein includes a guided navigational mode wherein the educational system presents to the child one or more activities in one or more subjects selected by a mentor from among a population of activities to create a subpopulation of activities. In some embodiments, in guided navigational mode, the child selects activities from among the subpopulation of activities.

In some embodiments, the educational environment disclosed herein includes an independent navigational mode wherein the child freely selects activities from among the full population of activities.

In still further embodiments, the child has the option to switch between available navigational modes. In some embodiments of the educational system disclosed herein, the availability of each navigational mode is determined by a mentor to the child or by an instructional designer. In further embodiments, the child has the option to freely use any navigational mode offered by the educational system. In other embodiments, the child has the option to select one or more navigational modes in a settings area of the educational environment. In some of these embodiments, the flexibility in finding, browsing, and exploring learning activities provided by multiple navigational modes contributes to the interactive and immersive nature of the educational system.

In some embodiments, the top-level and sub-level GUIs include multiple tabs that provide quick access to commonly used immersive and interactive features of the educational system including, by way of non-limiting examples, a subpopulation of activities selected by a mentor, a representation of a predetermined sequence of activities, a library of activities designated as favorites, a store for creating, maintaining, and enhancing the child's avatar, a virtual mail system, and stores for spending units awarded in a virtual economy.

In some embodiments, the educational system described herein further includes a software module adapted for conducting e-commerce transactions. In view of the disclosure provided herein, the software module is created by techniques known to those of skill in the art using machines, software, and languages known to the art. In some embodiments, the e-commerce transactions provide monthly subscription-based access to the educational environment. In some embodiments, the e-commerce transactions provide weekly, quarterly, or yearly subscription-based access to the educational environment. In some embodiments, the e-commerce transactions are sales of other services to the child or a mentor to the child. In some embodiments, the e-commerce transactions are sales of goods to the child or a mentor to the child. In other embodiments, the e-commerce transactions are sales of services, such as advertising services, to third parties.

In additional embodiments, the software module for conducting e-commerce transactions allows only authorized parties to conduct transactions. In further embodiments, a mentor to the child has the option to authorize the child to conduct e-commerce transactions within the educational environment. In other embodiments, no child is authorized to conduct e-commerce transactions within the educational environment.

### EXAMPLE

The following illustrative example is representative of an embodiment of the educational system described herein and is not meant to be limiting in any way.

### Example

### Immersive and Interactive Educational System

An immersive and interactive educational system is developed that provides visual and audio content to a digital processing device via the Internet. The digital processing device is a desktop personal computer system with a CPU, memory, a liquid crystal flat panel display, stereo speakers, a mouse, and a keyboard. The desktop computer is connected to the Internet by a DSL modem communicating at 3 Mbps such that the computer has continuous access to the World Wide Web. The visual and audio content is primarily in Adobe® Flash® format and is deployed in web pages primarily composed of XHTML, Javascript, and CSS code. The visual and audio content along with other instructions executed in the CPU of the computer creates an immersive and interactive educational environment.

The educational environment is designed for use by children aged 2 to 6 and offers learning activities teaching toward educational objectives in four subjects; namely, reading, math, science, and art. Each subject includes six levels of learning designed to appeal to and challenge children of different stages of learning within the age range. The activities associated with each subject include interactive virtual books, crossword puzzles, jigsaw puzzles, and songs. The activities are designed by an instructional designer to be interconnected by an instructional plan to accomplish one or more specific educational objectives through the mutual reinforcement of individual activities that address different modes of learning. The educational system is represented by a top-level GUI that resembles a preschool classroom environment and includes a representation of a teacher.

The educational system is used with a 4-year-old attending a private preschool. Her mentor, in this case, her preschool teacher, creates an account for her in the educational system. Her teacher selects an appropriate level for her and instructs the child on how to log in and navigate the environment. The child creates an avatar for herself and customizes her avatar's physical features and clothing. The child views her educational level as a representation of a road and can see lessons addressing all four subjects along the road. The lessons are composed of groups of activities.

After clicking with her mouse on the first lesson, which is a science lesson, the child participates in a puzzle activity. The puzzle is a jigsaw activity teaching toward an educational objective in science. After she completes the puzzle the child is awarded two tickets. The child moves on to another activity in the first lesson and participates in reading and listening to an interactive book also teaching toward an educational objective in science. After she completes all the pages of the book, the child is awarded an additional three tickets. Between each activity, the child is motivated by a visual indicator of the percentage of activities in the level she has completed. The indicator displays the percentage complete as a vertical bar chart.

The child navigates to a virtual store designed for exchange of tickets for items to be used in the educational environment. In an avatar store, she views a pair of sandals for her avatar. To add the sandals to her avatar, she needs six tickets. Only having five, the child navigates back to the path representing her level of learning and listens to a song, which is the final activity in the first lesson. After being awarded a sixth ticket, the child navigates back to the store and exchanges her tickets for the pair of sandals for her avatar.

The child spends twenty-five minutes engaged in the educational environment during this process. The next day, her teacher views a display of the child's progress and can see that the child has completed three activities, what types of activities they are, and what percentage of the level of learning, as well as each subject, that the child has completed.

What is claimed is:

1. An immersive and interactive educational system for a child aged about 1 to about 10 years, comprising:
(a) a digital processing device that is connected to the Internet comprising an operating system configured to perform executable instructions and which comprises a memory device, a display, a sound output device, and an input device and is characterized as being suitable for use by the child;
(b) visual and audio content provided to the digital processing device via the Internet, and at least partially stored in the memory of the digital processing device, that creates an immersive and interactive educational environment for the child, wherein the educational environment is further characterized by comprising:
i. at least three subjects appropriate for the child, wherein each subject comprises a plurality of levels of learning;
ii. a plurality of activities associated with each subject; wherein the plurality of activities teaches toward one or more educational objectives in a subject; wherein the plurality of activities is substantially free of activities not teaching toward one or more educational objectives in a subject; wherein the activities associated with each subject includes a book and at least one additional activity appropriate for the child; wherein one or more of the activities comprises a plurality of skill levels;
iii. a software module for monitoring the progress of the child in each of the subjects;
iv. a software module for rewarding the child for completing an activity; and
v. a software module for creating an avatar to represent the child.

2. The educational system of claim 1, wherein each activity in said plurality of activities is interconnected by an instructional plan designed to accomplish one or more specific educational objectives through the mutual reinforcement of individual activities that address different modes of learning.

3. The educational system of claim 1, wherein one or more activities in said plurality of activities is available in a language other than English.

4. The educational system of claim 1, wherein the system is for a child aged about 2 years to about 6 years.

5. The educational system of claim 1, wherein the visual and audio content is in a format selected from one or more of: Flash®, QuickTime®, Real Media®, Windows Media®, Silverlight®, Java™, HTML 5, XHTML 5, and Unity®.

6. The educational system of claim 1, wherein the visual and audio content is substantially in Adobe® Flash® format.

7. The educational system of claim 1, further comprising a top-level graphic user interface characterized by representing a classroom environment.

8. The educational system of claim 1, further comprising a top-level graphic user interface characterized by including a representation of a teacher, wherein a mentor to the child has the option to customize the appearance of the teacher.

9. The educational system of claim 1, further comprising a top-level graphic user interface characterized by representing an environment retentive for the child such as a zoo, farm, library, campus, amusement park, carnival, shopping mall, grocery store, laboratory, garage, or medical facility.

10. The educational system of claim 1, wherein at least one subject is selected from language arts, mathematics, social studies, science, music and other performing arts, visual art, additional languages, health, fitness and sports, and information technology.

11. The educational system of claim 1, wherein each subject comprises at least three levels of learning.

12. The educational system of claim 1, wherein each subject comprises six levels of learning.

13. The educational system of claim 1, wherein one or more subjects further comprises a level of learning for toddlers.

14. The educational system of claim 1, wherein the plurality of activities associated with each subject includes one or more puzzles, wherein at least one puzzle is a jigsaw puzzle or a cutout puzzle.

15. The educational system of claim 1, wherein one or more puzzles includes a spoken word audio component.

16. The educational system of claim 1, wherein the plurality of activities associated with each subject includes one or more music activities, wherein at least one music activity is a song, book, puzzle, game, art activity, printable, or interactive musical instrument.

17. The educational system of claim 16, wherein said songs comprise audio of the lyrics sung, a progress indicator, a volume control, play/pause controls, text of the lyrics, and optionally, a bouncing ball animation corresponding to the audio.

18. The educational system of claim 17, wherein said songs further comprise an instrumental version of the song, a means to record singing of the lyrics, and a means for the child or a mentor to share songs personalized by singing with others.

19. The educational system of claim 1, wherein the plurality of activities associated with each subject includes one or more art activities, wherein at least one art activity is drawing, tracing, dot-to-dot, coloring, painting, paint-by number, paint-by-letter, or paint-by-word.

20. The educational system of claim 1, wherein said books comprise pages with text and images, an animated page flipping format, an automatic page flipping mode, a manual page flipping mode, audio of the book read, play/pause controls, a progress indicator, and optionally, highlighting of words in the book corresponding to the audio.

21. The educational system of claim 1, wherein said books comprise a single page with text and images, audio of the book read, play/pause controls, a progress indicator, and optionally, highlighting of words in the book corresponding to the audio, wherein the book is adapted for content such as nursery rhymes and short poems.

22. The educational system of claim 1, wherein said books comprise audio of the book read, images corresponding to the audio, play/pause controls, and a progress indicator, wherein the books is adapted for use by a toddler.

23. The educational system of claim 1, wherein said books further comprise a means to record voice narration of the story of the book and a means for the child or a mentor to share books personalized by narration with others.

24. The educational system of claim 1, wherein the plurality of activities associated with each subject includes one or more games, wherein at least one game is designed to increase skills in academic topics such as letter recognition, letter sounds, letter tracing, letter matching, letter fill-in, word recognition, word sounds, word tracing, spelling, number recognition, counting, number tracing, number matching, number fill-in, more or less, shape tracing, shape recognition, primary color recognition, secondary color recognition, color matching, or animal recognition.

25. The educational system of claim 1, wherein the plurality of activities associated with each subject includes some content unique to the educational system and not available elsewhere.

26. The educational system of claim 1, wherein one or more activities comprises between two and fifteen skill levels.

27. The educational system of claim 3, wherein one or more activities is available in a language selected from English, Spanish, Italian, Portuguese, French, Dutch, Polish, German, Russian, Ukrainian, Mandarin, Wu, Cantonese, Hindi, Punjabi, Bengali, Marathi, Urdu, Arabic, Turkish, Tamil, Farsi, Japanese, Korean, Vietnamese, Thai, Burmese, Malay, Telugu, and Javanese.

28. The educational system of claim 1, wherein one or more activities is available in Spanish.

29. The educational system of claim 1, further comprising a software module for designating favorite activities, wherein the child has the option to access a library of activities the child has designated as favorites.

30. The educational system of claim 1, further comprising a software module for rating activities, wherein the child has the option to express an opinion of one or more activities.

31. The educational system of claim 30, wherein the child has the option to express an opinion of one or more activities on a numeric scale from one to five.

32. The educational system of claim 1, further comprising a directory of printable activities, wherein at least one printable activity is coloring, drawing, writing, tracing, dot-to-dot, paint-by-number, paint-by-letter, or paint-by-word.

33. The educational system of claim 1, further comprising one or more of: a glossary of words used in one or more activities.

34. The educational system of claim 33, wherein said glossary comprises one or more entries, wherein said entries comprise a word, a definition of the word, and the word used in a sentence; optionally, said entries further comprise audio of the word and definition read; optionally, said entries further comprise an image, video, or animation associated with the word.

35. The educational system of claim 33, wherein said glossary is contextual, wherein the entries available at any given time comprise words used in the current learning activity.

36. The educational system of claim 1, further comprising at least one of an encyclopedia, a dictionary, or a thesaurus.

37. The educational system of claim 1, further comprising a farm-themed sub-level graphic user interface.

38. The educational system of claim 1, further comprising a zoo-themed sub-level graphic user interface.

39. The educational system of claim 1, further comprising one or more sub-level graphic user interfaces with a theme conducive to engaging the child such as a library, laboratory, medical facility, city, sporting event, school bus, amusement park, carnival, shopping mall, market, kitchen, garage, museum, playground, garden, desert, mountain, lake, undersea environment, extraterrestrial environment, and arctic or Antarctic environment.

40. The educational system of claim 1, further comprising an interactive calendar.

41. The educational system of claim 1, further comprising one or more interactive maps.

42. The educational system of claim 41, wherein at least one interactive map is an interactive United States map.

43. The educational system of claim 1, further comprising an interactive clock.

44. The educational system of claim 1, further comprising an interactive aquarium.

45. The educational system of claim 1, wherein the software module for monitoring the progress of the child allows both the child and a mentor to the child to independently monitor the progress of the child in each subject and each level of learning within each subject.

46. The educational system of claim 1, wherein the software module for monitoring the progress of the child in each of the subjects includes progress displays adapted for use by the child or a mentor to the child.

47. The educational system of claim 46, wherein said progress displays indicate percentage completion of one or more subjects, percentage completion of one or more levels of learning within each subject, and completion of each activity associated with each subject.

48. The educational system of claim 46, wherein the software module for monitoring the progress of the child in each of the subjects includes printable reports adapted for use by the child or a mentor to the child.

49. The educational system of claim 1, wherein the software module for monitoring the progress of the child includes a visual indicator adapted for use by the child, wherein said visual indicator displays the percentage of the activities completed within a level of learning.

50. The educational system of claim 1, wherein the software module for monitoring the progress of the child includes a visual indicator adapted for use by the child, wherein said visual indicator displays the activities completed within a level of learning, said visual indicator characterized by representing the level of learning as a linear succession and representing lessons comprising groups of activities as points in the linear succession.

51. The educational system of claim 1, wherein said linear succession is further represented as a map, path, or road and said lessons comprising groups of activities are further represented as waypoints or stops on the map, path, or road.

52. The educational system of claim 51, wherein the software module for monitoring the progress of the child further includes a visual indicator adapted for use by the child, wherein said visual indicator displays said lessons as a group of selectable activity icons.

53. The educational system of claim 52, wherein said group of selectable activity icons is further represented on a whiteboard, chalkboard, or bulletin board.

54. The educational system of claim 1, wherein the software module for rewarding the child creates a virtual economy, said virtual economy comprising one or more units awarded for completing an activity and one or more stores for spending awarded units on virtual items used in the educational system.

55. The educational system of claim 54, wherein said units are represented as virtual tickets.

56. The educational system of claim 54, wherein at least one store for spending awarded units is an avatar store, a pet store, an arcade, a movie theater, an aquarium store, or an emoticon store.

57. The educational system of claim 1, wherein the software module for creating an avatar to represent the child includes means for selecting clothing, physical features, and items associated with the child's avatar used in the educational system.

58. The educational system of claim 57, wherein said software module for creating an avatar to represent the child further includes means for capturing, zooming, and panning images of the child's avatar for display in the educational system.

59. The educational system of claim 1, further comprising a software module for authoring and receiving virtual mail, wherein said software module is adapted for use by the child and only allows communication with other child users of the educational system.

60. The educational system of claim 1, further comprising a software module adapted for conducting e-commerce transactions.

61. The educational system of claim 60, wherein said software module for conducting e-commerce transactions allows only authorized parties to conduct transactions.

62. The educational system of claim 60, wherein said e-commerce transactions provide subscription-based access to said educational environment.

63. The educational system of claim 1, wherein said system complies with the requirements of the Children's Online Privacy Protection Act of 1998 (“COPPA”) delineated at 15 U.S.C. §§6501-6508.

64. The educational system of claim 1, further comprising an absence of third party advertising.

65. The educational system of claim 1, further comprising an absence of direct links to third party websites.

66. Computer readable media encoded with a computer program comprising instructions executable by a digital processing system for delivering visual and audio content to create an immersive and interactive educational environment for a child aged about 1 to about 10 years, wherein said web-based educational environment is further characterized by comprising:
(a) at least three subjects appropriate for the child, wherein each subject comprises a plurality of levels of learning;
(b) a plurality of activities associated with each subject; wherein the plurality of activities teaches toward one or more educational objectives in a subject; wherein the plurality of activities is substantially free of activities not teaching toward one or more educational objectives in a subject; wherein the activities associated with each subject include a book and at least one additional activity appropriate for the child; wherein one or more of the activities comprises a plurality of skill levels;
(c) a software module for monitoring the progress of the child in each of the subjects;
(d) a software module for rewarding the child for completing an activity; and
(e) a software module for creating an avatar to represent the child.

67. A method of facilitating the educational development of a child aged about 1 to about 10 years comprising the step of:
(a) providing executable instructions and visual and audio content via the Internet to a digital processing device comprising an operating system configured to perform executable instructions, a memory device, a display, a sound output device, and an input device wherein said visual and audio content is at least partially stored in the memory of the digital processing device and creates an immersive and interactive educational environment for the child, wherein said educational environment is further characterized by comprising:
i. at least three subjects appropriate for the child, wherein each subject comprises a plurality of levels of learning;
ii. a plurality of activities associated with each subject; wherein the plurality of activities teaches toward one or more educational objectives in a subject; wherein the plurality of activities is substantially free of activities not teaching toward one or more educational objectives in a subject; wherein the activities associated with each subject include a book and at least one additional activity appropriate for the child; wherein one or more of the activities comprises a plurality of skill levels;
iii. a software module for monitoring the progress of the child in each of the subjects;
iv. a software module for rewarding the child for completing an activity; and
v. a software module for creating an avatar to represent the child.
